(19) United States
(12) Patent Application Publication
(10) Pub. No.: US 2024/0196304 A1
(43) Pub. Date: Jun. 13, 2024

(54) ROUTING DATA IN AN INTEGRATED ACCESS AND BACKHAUL NETWORK

(71) Applicant: CANON KABUSHIKI KAISHA, Tokyo (JP)

(72) Inventors: Pierre VISA, RENNES (FR); Pascal LAGRANGE, LA CHAPELLE DES FOUGERETZ (FR)

(21) Appl. No.: 18/554,431

(22) PCT Filed: Apr. 7, 2022
(86) PCT No.: PCT/EP2022/059339

§ 371 Date: Oct. 6, 2023

(30) Foreign Application Priority Data
Apr. 9, 2021 (GB) 2105122.2

(51) Int. Cl. H04W 40/22; H04L 45/745; H04W 40/34

(52) U.S. Cl. CPC H04W 40/22; H04L 45/745; H04W 40/34

(57) ABSTRACT

A method, at an IAB network node, for routing data packets over one or more wireless backhaul links in an integrated access and backhaul, IAB, network comprising a donor network node, having a donor CU and a plurality of donor DUs, and a plurality of IAB network nodes is disclosed. Each donor DU and IAB network node are assigned a unique address and each donor DU is assigned to one of one or more groups with a unique group identifier assigned to each group of the one or more groups. The IAB network node is configured with routing configuration information including a unique address of at least one donor DU corresponding to at least one destination donor DU, at least one path identifier identifying at least one routing path to the at least one destination donor DU, the unique address of a donor DU or IAB network node of the IAB network that is a next node in the at least one routing path and the group identifier associated with the at least one destination donor DU. The method comprises: receiving a data packet for a destination donor DU, the data packet including the unique address of the destination donor DU for the data packet and a path identifier identifying the routing path to the destination donor DU; determining whether there is an available routing path to the destination donor DU based on the unique address of the destination donor DU and the path identifier included in the data packet and the routing configuration information, and based on the unique address of the destination donor DU included in the data packet and the routing configuration information. When no available routing path is determined, the method further comprises determining an alternate routing path for the data packet for the destination donor DU using the routing configuration information and based on the unique address of the destination donor DU and the group identifier associated with the destination donor DU, wherein the alternate routing path is to a different destination donor DU in the same group as the destination donor DU with the same group identifier; and routing the data packet using the determined alternate routing path.

### FIELD OF THE INVENTION

The present invention generally relates to routing data and managing routing of data in an integrated access and backhaul, IAB, network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems-based IEEE 802.11 standards, such as WiFi.

The demand for network densification (e.g. denser placement of base stations) increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications or links (between base stations) may use the same radio resources as access communications or links (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

However, millimeter waves are known to be subject to strong attenuations of signal strength in some weather conditions (rain, fog), and to blockage in case of obstacles located in the path between the emitter and the receiver.

To cope with these potential radio link failures, a topological redundancy can be provided within the IAB framework, where multiple backhaul paths are set up between the IAB base station directly connected to the core network (also referred to as the “IAB-donor”) and the IAB base station serving a UE (also referred to as the “access IAB-node” for the UE). Several intermediate IAB base stations (also referred to as IAB-nodes) may be involved in each of the several backhaul paths between the IAB-donor and the access IAB-node, thus forming alternative data paths within a multi-hop IAB network.

A path through a set of IAB-nodes is defined by default along which the data are preferably transmitted. Also, one or more back-up paths along different sets of IAB-nodes are defined that can be used in case a radio link failure (RLF) occurs on any link of the default path. A link is defined between two successive IAB-nodes in the backhaul network. A back-up path is also useful in case of congestion of a link due to an excessive demand of application traffic compared to the default link capacity. Traffic re-routing to a back-up path or load balancing between the default path and one or more back-up paths may be activated to mitigate the congestion.

In the IAB-network topology, the direction from the IAB-donor toward the access IAB-nodes (and thus the UEs) is referred to as downstream, hence defining a parent IAB-node and a child IAB-node for each link. The direction toward the IAB-donor is referred to as upstream. Each IAB-node coupled directly or indirectly to the IAB-donor comprises an IAB-MT (IAB-Mobile Termination) to communicate in the upstream direction and an IAB-DU (IAB-Distributed Unit) to communicate in the downstream direction.

Like a legacy 5G base station (gNB), the IAB-donor consists of a central unit (CU or gNB-CU functionality) and of one or more distributed unit(s) (DU or gNB-DU functionality). The IAB-donor-CU hosts higher layer protocols for controlling operation of one or more DUs and each of the one or more IAB-donor-DUs include lower layer protocols including the Physical layer and Radio Frequency part. The IAB-donor-CU and the one or more IAB-donor-DUs may be located far from each other. Then a wired IP network (typically with fiber connections) exists to interconnect these different devices. The interest of having several DUs connected to a single CU is the centralization and the resource sharing of less time-critical operations in the CU (virtualization), while time-critical operations like scheduling, fast retransmission, segmentation, etc. are performed in the DUs. As a consequence, in the downstream direction, there may be several backhaul paths from the IAB-donor-CU to an IAB-node through different IAB-donor-DUs. Similarly in upstream direction, there may be several possible backhaul paths from the source IAB-node to reach the IAB-donor-CU through different IAB-donor-DUs.

To enable routing over multiple backhaul hops, a specific IAB protocol sublayer is introduced, the backhaul adaptation protocol (BAP) sublayer, which is specified in the 3GPP release-16 specifications TS 38.340 (version 16.3.0). There is one BAP entity in each IAB-MT, one BAP entity in each IAB-DU, and one BAP entity in each IAB-donor-DU. A unique BAP address is assigned to each IAB-node and to each IAB-donor-DU. The BAP sublayer encapsulates IP SDUs (Service Data Units) into BAP PDUs (Protocol Data Units), where each BAP PDU consists of a BAP header and a payload section, which includes the IP SDUs.

The BAP header includes a BAP Routing ID, which is the concatenation of the destination BAP address and the identifier of the backhaul path to follow (Path ID). The BAP routing ID is set by the BAP sublayer of the initiator IAB-donor-DU (in the downstream direction) or the initiator IAB-node (in the upstream direction). Then, BAP PDUs are routed according to the BAP Routing ID using a backhaul routing table configured by the IAB-donor-CU in each IAB-node and in each IAB-donor-DU. Upon reception of a BAP PDU in a BAP entity, the destination BAP address is compared to the local BAP address. If the local address matches with the destination BAP address, the BAP header is removed and the payload is delivered to the upper layers.

For a BAP entity in an IAB-donor-DU, if the destination BAP address does not match the local BAP address, the BAP PDU is discarded. For a BAP entity in the IAB-MT or the IAB-DU of an IAB-node, if the destination BAP address does not match the local BAP address, the BAP PDU is delivered to the collocated BAP entity for routing and transmission to the next hop. The backhaul routing table provides the egress link corresponding to the next hop BAP address, using the BAP routing ID in the BAP PDU header as the entry of the table. In case the indicated egress link is not available, for instance due to radio link failure (RLF), an entry with the same destination BAP address is selected regardless of the Path ID. The BAP PDU is discarded if no entry in the routing table matches the BAP Routing ID or the destination BAP address of the BAP header.

According to the described behavior, the IAB release 16 does not allow to re-route BAP PDUs in upstream direction towards a different IAB-donor-DU, even though several IAB-donor-DUs provide a connection to the same IAB-donor-CU. Indeed, in the upstream direction the destination BAP address of BAP PDUs corresponds to one of the several IAB-donor-DUs available. As the IAB-donor-DUs are set with different BAP addresses, an IAB-node may find an alternative path in its routing table to reach the IAB-donor-DU targeted by the destination BAP address, but it has no information to identify an alternative IAB-donor-DU that could be reached through an alternative path.

Moreover, assuming a BAP PDU arrives at the alternative IAB-donor-DU, this latter would discard the BAP PDU as the destination BAP address would not match its own BAP address.

Further, assuming that an alternative IAB-donor-DU has received the BAP PDU, the IP packet delivered to the upper layers may be discarded due to the filtering applied by routers on the wireline network connecting the IAB-donor-DUs and the IAB-donor-CU. Indeed, the source IP address is set by the initiator IAB-node with an IP address allocated by the IAB-donor-DU initially targeted. If the IP packet is received in an alternative IAB-donor-DU, then it may be discarded by a router receiving this IP packet from the alternative IAB-donor as it carries a non-local source IP address. Such IP filtering is generally considered as a security feature to protect against attacks, and so it should not be deactivated.

Accordingly, a solution to at least one of the aforementioned problems is desirable.

### SUMMARY

In accordance with a first aspect of the present invention there is provided a method for managing routing of data packets over wireless backhaul links in an integrated access and backhaul, IAB, network comprising a donor network node and a plurality of IAB network nodes, the donor network node comprising a donor central unit, CU, and a plurality of donor distributed units, DUs, each donor DU being assigned a unique address and each donor DU being assigned to one of one or more groups with a unique group identifier assigned to each group of the one or more groups, the method at the donor CU comprising:
providing to each donor DU, the unique address of the donor DU and the group identifier associated with the donor DU; and
providing routing configuration information to the plurality of IAB network nodes, the routing configuration information including the unique addresses of the donor DUs corresponding to destination donor DUs for data packets to be transmitted to the donor CU, path identifiers identifying routing paths to the destination donor DUs, and the group identifiers associated with the destination donor DUs.

The method may further comprise receiving a data packet for a destination donor DU from the destination donor DU or a different donor DU in the same group as the destination donor DU with the same associated group identifier.

In an example, the routing configuration information may comprise a routing configuration table including at least one of entry, each entry having a destination address field for the unique address of a destination donor DU, a path identifier field for the path identifier of a routing path to the destination donor DU, a group identifier field for the group identifier associated with the destination donor DU.

In another example, the routing configuration information may comprise a routing configuration table including at least one entry, each entry having a destination address field for the unique address of a destination donor DU and the group identifier associated with the destination donor DU, and a path identifier field for the path identifier of a routing path to the destination donor DU.

The group identifier may be represented by one or more bits in the group identifier field or the destination address field of the routing configuration table.

The group identifier may be a group address (e.g. having the same format as a unique address of a IAB node).

In an example where the group identifier is a group address, the routing configuration information may comprise a routing configuration table including at least one entry, each entry having a destination address field for the unique address of a destination donor DU or the group address of the destination donor DU, and a path identifier field for the path identifier of a routing path to the destination donor DU.

The routing configuration table may further comprise a next-hop address field for the unique address of a donor DU or IAB network node of the IAB network that is next in the routing path.

Each group of the one or more groups may be associated with a respective IP subnetwork of an IP network coupled between the donor CU and the plurality of donor DUs.

In accordance with a second aspect of the present invention, there is provided a method, at an IAB network node, for routing data packets over one or more wireless backhaul links in an integrated access and backhaul, IAB, network comprising a donor network node and a plurality of IAB network nodes, the donor network node comprising a donor central unit, CU, and a plurality of donor distributed units, DUs, each donor DU and IAB network node being assigned a unique address and each donor DU being assigned to one of one or more groups with a unique group identifier assigned to each group of the one or more groups, the IAB network node being configured with routing configuration information including a unique address of at least one donor DU corresponding to at least one destination donor DU for data packets to be transmitted by the IAB network node, at least one path identifier identifying at least one routing path to the at least one destination donor DU, the unique address of a donor DU or IAB network node of the IAB network that is a next node in the at least one routing path and the group identifier associated with the at least one destination donor DU, the method comprising:
receiving a data packet for a destination donor DU, the data packet including the unique address of the destination donor DU for the data packet and a path identifier identifying the routing path to the destination donor DU;
determining whether there is an available routing path to the destination donor DU based on the unique address of the destination donor DU and the path identifier included in the data packet and the routing configuration information, and based on the unique address of the destination donor DU included in the data packet and the routing configuration information,
when no available routing path is determined, determining an alternate routing path for the data packet for the destination donor DU using the routing configuration information and based on the unique address of the destination donor DU and the group identifier associated with the destination donor DU, wherein the alternate routing path is to a different destination donor DU in the same group as the destination donor DU with the same group identifier; and
routing the data packet using the determined alternate routing path.

In an example, the data packet may include a header comprising the unique address of the destination donor DU for the data packet. When the data packets is to be routed using a routing path to a different donor DU in the same group as the destination donor DU, the method further comprises updating the header of the data packet to include the unique address of the different donor DU or to replace the unique address of the destination donor DU with the unique address of the different donor DU, wherein routing the data packet comprises routing the data packet including an updated header.

By updating the header to include the unique address of the different donor DU, the specifications of the routing and receiving operations in the BAP sublayer of the next network node(s) in the routing path may be unchanged. Furthermore, additional processing at the different donor DU, which would be required to avoid data packets being discarded if the header was not updated, can be avoided.

The routing configuration information may comprise a routing configuration table including at least one entry, each entry having:
a destination address field for the unique address of a destination donor DU, a path identifier field for the path identifier of a routing path to the destination donor DU, a next-hop address field for the unique address of a donor DU or IAB network node of the IAB network that is a next node in the routing path, and a group identifier field for the group identifier associated with the destination donor DU; or
a destination address field for the unique address of the destination donor DU and the group identifier associated with the destination donor DU, a path identifier field for the path identifier of a routing path to the destination donor DU, and a next-hop address field for the unique address of a donor DU or IAB network node of the IAB network that is a next node in the routing path.

When the routing configuration information comprises a routing configuration table, determining whether there is an available routing path to the destination donor DU comprises:
comparing the unique address of the destination donor DU and the path identifier included in the data packet with the routing configuration table and when there is a match with a unique address and path identifier in an entry of the routing configuration table, checking whether a backhaul wireless link to a next node in the routing path identified by the unique address in the next-hop address field for the entry is available; and
when the backhaul wireless link is not available or there is no match with a unique address and path identifier in the routing configuration table, comparing the unique address of the destination donor DU included in the data packet with the routing configuration table and when there is a match with a unique address in an entry of the routing configuration table, checking whether a backhaul wireless link to a next node identified by the unique address in the next-hop address field for the entry is available, wherein no available routing path is determined when there is no match with a unique address in the routing configuration table or the backhaul wireless link is not available,
wherein determining an alternate routing path comprises:
identifying another entry in the routing configuration table having the same group identifier as the group identifier for an entry having at least the unique address of the destination donor in the destination address field, and determining, from the next-hop address field of the another entry, an alternate routing path to a different destination donor DU in the same group as the destination donor DU.

Routing the data packet using the determined alternate routing path may comprise checking whether a backhaul wireless link to a next node in the routing path identified by the unique address in the next-hop address field for the another entry is available and when the backhaul wireless link is available routing the data packet using the determined alternate routing path.

In an example, the group identifier may comprise a group address. Each of the donor DUs in a group is assigned the same group address such that each donor DU is assigned a unique address and a group address.

With such an example, the routing configuration information may comprise a routing configuration table including at least one entry, each entry having a destination address field for the unique address of a destination donor DU or the group address of the destination donor DU, a path identifier field for the path identifier of a routing path to the destination donor DU and a next-hop address field for the unique address of a donor DU or IAB network node of the IAB network that is next in the routing path.

Determining whether there is an available routing path to the destination donor DU may comprise:
comparing the unique address of the destination donor DU and the path identifier included in the data packet with the routing configuration table and when there is a match with a unique address and path identifier in an entry of the routing configuration table, checking whether a backhaul wireless link to a next node in the routing path identified by the unique address in the next-hop address field for the entry is available; and
when the backhaul wireless link is not available or there is no match with a unique address and path identifier in the routing configuration table, comparing the unique address of the destination donor DU included in the data packet with the routing configuration table and when there is a match with a unique address in an entry of the routing configuration table, checking whether a backhaul wireless link to a next node identified by the unique address in the next-hop address field for the entry is available, wherein no available routing paths are determined when there is no match with a unique address in the routing configuration table or the backhaul wireless link is not available,
wherein determining an alternate routing path comprises:
identifying another entry in the routing configuration table having the group address corresponding to the unique address or the same group address as the group address for an entry having the unique address of the destination donor in the destination address field and determining, from the another entry, an alternate routing path to a different destination donor DU with the same group address as the destination donor DU.

In an example where the group identifier comprises a group address, the method may further comprise generating a data packet for routing to a destination donor DU, wherein the data packet includes the unique address or the group address of the destination donor DU.

In accordance with a third aspect of the present invention, there is provided a method for processing data packets at a donor DU of a wireless integrated access and backhaul, IAB, network comprising a donor network node and a plurality of IAB network nodes, the donor network node comprising a donor central unit, CU, and a plurality of donor distributed units, DUs, each donor DU being assigned a unique address and each donor DU being assigned to one of one or more groups with a unique group identifier assigned to each group of the one or more groups, the donor DU being configured with configuration information including the unique address of the donor DU and the group identifier associated with the donor DU, the method comprising:
receiving a data packet, the data packet including a header comprising the unique address of a donor DU corresponding to a destination donor DU for the data packet;
determining whether the unique address in the header matches the unique address of the donor DU in the configuration information;
when the unique addresses do not match, determining whether a predetermined filtering condition is met; and
when the predetermined filtering condition is met, accepting the received data packet for further processing.

In accordance with a fourth aspect of the present invention, there is provided a method for processing data packets at a donor DU of a wireless integrated access and backhaul, IAB, network comprising a donor network node and a plurality of IAB network nodes, the donor network node comprising a donor central unit, CU, and a plurality of donor distributed units, DUs, each donor DU being assigned a unique address and each donor DU being assigned to one of one or more groups with a group address assigned to each group of the one or more groups, wherein each of the donor DUs in a group is assigned the same group address such that each donor DU is assigned a unique address and a group address, the donor DU being configured with configuration information including the unique address of the donor DU and the group address associated with the donor DU, the method comprising:
receiving a data packet, the data packet including a header comprising the unique address of a donor DU or the group address of the donor DU corresponding to a destination donor DU for the data packet;
determining whether the unique address or the group address in the header matches the unique address or the group address of the donor DU in the received routing configuration information; and
when the unique addresses or the group addresses match, accepting the received data packet for further processing.

In an example, when the unique addresses or the group addresses do not match, determining whether a predetermined filtering condition is met and when the predetermined filtering condition is met, accepting the received data packet for further processing.

The predetermined filtering condition may include one of:
all data packets received at the donor DU can be accepted for further processing; or
the unique address in the header of the data packet matches a unique address included in a list of unique addresses of acceptable donor DUs provided to the donor DU by the donor CU; or
the header of the data packet includes a group identifier that matches a group identifier provided to the donor DU by the donor CU.

The method may further comprise receiving from the donor CU an Information Element including filtering configuration information relating to the predetermined filtering condition.

By means of the group identifier (such as one or more bits in a separate group identifier field or one or more bits which are part of the destination address field or a group address (secondary address) in the destination address field) including in the routing configuration table(s), an IAB node willing to re-route a data packet will be able to select an alternative donor DU that allows effective re-routing to the donor CU.

Each group may be identified by a unique group identifier (such as one or more bits in a separate group identifier field or one or more bits which are part of the destination address field or a group address (secondary address) in the destination address field) including in the routing configuration table(s) or a unique group identifier provided separately to the donor DU. The grouping of donor DUs into groups may be based, for example, on the IP filtering policy in the wired backhaul network (or IP backhaul network) between the donor DUs and the donor CU. For example, the donor DUs can be grouped into groups corresponding to IP subnetworks in the backhaul network. By grouping the donor DUs into groups corresponding to IP subnetworks of an IP backhaul network coupled between the donor CU and the donor DUs, the re-routing of data packets, such as BAP packets, will be possible to different donor DUs belonging to the same group and the data packets will not be discarded based on IP filtering functions.

In accordance with a fifth aspect, there is provided a method for managing routing of data packets over wireless backhaul links in an integrated access and backhaul, IAB, network as recited in any one of claims 24 to 27 of the accompanying claims.

In accordance with a sixth aspect, there is provided a method, at an IAB network node, for routing data packets over one or more wireless backhaul links in an integrated access and backhaul, IAB, network as recited in any one of claims 28 to 30 of the accompanying claims.

In accordance with a seventh aspect, there is provided a method for processing data packets at a donor DU in a wireless integrated access and backhaul, IAB, network as recited in any one of claims 31 to 33 of the accompanying claims.

In accordance with an eighth aspect, there is provided a donor Central Unit, CU, as recited in claim 34.

In accordance with a ninth aspect, there is provided an Integrated access and backhaul, IAB, network node, as recited in claim 35.

In accordance with a tenth aspect, there is provided a donor Distributed unit, DU, as recited in claim 36.

The data packets may be Backhaul Adaptation Protocol (BAP) packets or BAP Packet Data Units (PDUs). The BAP PDUs may be BAP Data packets. For BAP packets, the routing configuration table is a BAP routing configuration table where the destination address field and the path identifier field are part of a BAP routing ID. In such a case, the BAP routing ID comprises the BAP destination address field for the unique BAP address of a donor DU which corresponds to the destination donor DU of the BAP packet and path identifier field for identifying the path or routing path to the destination donor DU. A BAP packet includes a BAP header which includes a BAP routing ID for routing the BAP packet. The routing ID of the BAP header includes a destination address field for the unique BAP address of a donor DU which corresponds to the destination donor DU of the BAP packet and path identifier field for identifying the path or routing path to the destination donor DU.

It will be appreciated that the difference aspects described above enable the re-routing of data packets (e.g. BAP packets) through an alternative IAB donor DU. Different ways (e.g. group identifier being a group ID or a group address or with additional entries in a routing configuration table) of indicating to the IAB network node that a data packet is to be re-routed to a different donor DU are provided. In the cases where the destination BAP address in the BAP routing ID of the re-routed packets will not match the alternative IAB donor DU, in order to avoid packet discarding at an IAB network node and at the alternative IAB donor DU, several options have been described above for the different aspects including updating the BAP routing ID to include the address of the alternative IAB donor DU as the destination address, using a group address (secondary address) and configuring the alternative IAB donor DU with a predetermined filtering condition which if met allows for the packets to be further processed even when the BAP routing ID of the re-routed packets do not match. By configuring the IAB donor DUs with a predetermined filtering condition and/or by grouping the donor DUs into groups corresponding to IP subnetworks, solutions are provided which are also in line with the IP filtering policy established in the wired IP backhaul network between IAB donor DUs and the IAB donor CU.

Further features of the invention are characterised by the other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with another aspect of the invention, there is provided a computer readable storage medium storing at least one computer program comprising instructions that, when executed by a processing unit, causes the processing unit to perform the method according to any aspect or example described above.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating a 5G Radio Access Network including a wireless Integrated Access and Backhaul (IAB) network;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a schematic diagram for illustrating the routing management in an IAB network;

FIG. 5 illustrates fields of routing tables in IAB-nodes according to 3GPP TS 38.300;

FIG. 6 is a schematic diagram illustrating an example topology of an IAB network presenting network path diversity in which the present invention may be implemented according to one or more exemplary embodiments;

FIG. 7 illustrates fields of an augmented BH routing configuration table according to an example of an embodiment of the invention;

FIG. 8 illustrates, using a flowchart, an exemplary method to route BAP PDUs in IAB-nodes or IAB-donor-DUs according to embodiments of the invention;

FIG. 9 illustrates, using a flowchart, an exemplary method for processing the received BAP PDUs in IAB-nodes or IAB-donor-DUs according to embodiments of the invention;

FIG. 10 is a schematic and simplified diagram illustrating an exemplary message flow for configuring the BH routing configuration table at an IAB-node and an IAB-donor-DU by the IAB-donor-CU, according to embodiments of the invention;

FIG. 10a is a schematic and simplified diagram illustrating an exemplary message flow for configuring the BAP filtering in IAB-donor-DU by the IAB-donor-CU, according to embodiments of the invention;

FIG. 11 is a block schematic diagram of an example wireless communication device for implementing embodiments of the present invention;

FIG. 12 illustrates, using a flowchart, an exemplary method, at a donor CU, for managing processing of data packets in a wireless IAB according to a first embodiment of the invention;

FIG. 13 illustrates, using a flowchart, an exemplary method, at an IAB node, for processing data packets in a wireless IAB according to a first embodiment of the invention;

FIG. 14 illustrates, using a flowchart, an exemplary method, at a donor DU, for processing data packets in a wireless IAB according to a first embodiment of the invention;

FIG. 15 illustrates, using a flowchart, an exemplary method, at a donor CU, for managing processing of data packets in a wireless IAB according to a second embodiment of the invention;

FIG. 16 illustrates, using a flowchart, an exemplary method, at an IAB node, for processing data packets in a wireless IAB according to a second embodiment of the invention;

FIG. 17 illustrates, using a flowchart, an exemplary method, at a donor DU, for processing data packets in a wireless IAB according to a second embodiment of the invention;

FIG. 18 illustrates an example of a routing configuration in an IAB network according to an embodiment of the invention.

### DETAILED DESCRIPTION

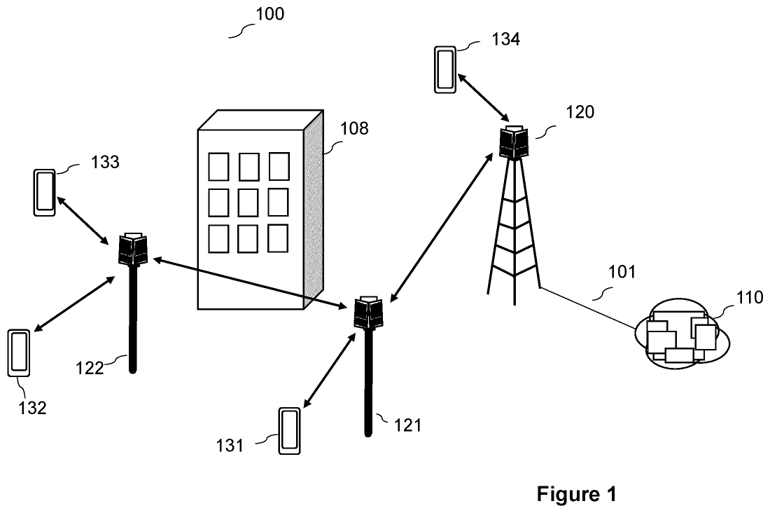

FIG. 1 illustrates a communication system 100 with a 5G Radio Access Network including a wireless IAB network.

As depicted, the exemplary system 100 is a wireless communication system, in particular a mobile radio communication system such as a fifth-generation (5G) New Radio (NR) system. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul network which shares radio resources for wireless access links and wireless backhaul links.

The system 100 comprises a plurality of UEs (User Equipment) 132, 133, 131 and 134, a remote core network 110, a main Base Station 120, and two Integrated Access and Backhaul (IAB) stations or IAB network nodes 121 and 122.

The main Base Station 120, also referred to as the IAB-donor or donor network node 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v16.2.0 specification document.

In order to extend the network coverage of IAB-donor 120 and reach the remote UEs 132, 133 and 131, IAB stations 121 and 122, also referred to as IAB-nodes or IAB network nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The IAB-donor 120 and the IAB-nodes 121 and 122 are thus forming a backhaul network or IAB network, which accommodates UEs 132, 133, 131 and 134.

The specification of the Integrated Access and Backhaul (IAB) is spread over several 3GPP standard documents, including:
TS 38.300 RAN architecture (V16.2.0),
TS 38.321 MAC protocol (V16.1.0),
TS 38.331 Radio Resource Control (RRC) protocol (V16.1.0),
TS 38.340 Backhaul Adaptation Protocol Layer (V16.1.0),
TS 38.401 RAN architecture (V16.2.0),
TS 38.473 F1 Application Protocol (V16.2.0).

As IAB-nodes 121 and 122 are respectively connected to UEs 131, 132 and 133, they are considered as Access IAB-nodes for their respectively connected UEs.

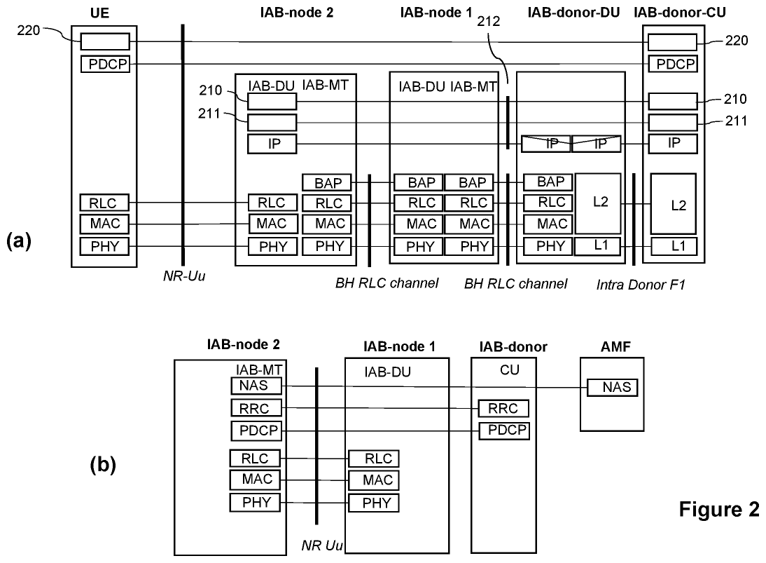

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU hosts higher layer protocols, such as PDCP (Packet Data Convergence Protocol) and RRC (Radio Resource Control) protocols, for controlling operation of one or more DUs and each of the one or more IAB-donor-DUs or donor DUs includes lower layer protocols, such as the RLC, MAC and physical layer protocols. The IAB-donor-CU or donor CU and IAB-donor-DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes 121, 122, which may serve multiple radio sectors, are wireless backhauled to the IAB-donor 120, via one or multiple hops. They form a directed acyclic graph (DAG) topology with the IAB-donor at its root.

Each IAB node or IAB network node consists of an IAB-DU and an IAB-MT (IAB-Mobile Termination). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case the IAB-MT connects to the IAB-donor-DU, hence to the IAB-donor gNB-CU and the core network 110, for instance for initialization, registration and configuration).

In this DAG topology, the neighbour node on the IAB-DU's interface is referred to as child node or child IAB-node, and the neighbour node on the IAB-MT's interface is referred to as parent node or parent IAB-node. The direction toward the child node is further referred to as downstream while the direction toward the parent node is referred to as upstream.

The IAB-donor 120 performs centralized resource, topology and route management for the whole IAB network topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node DU (e.g. of IAB-node 2), and between the IAB-donor-CU and an IAB-donor-DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane (UP), boxes 210 at the IAB-donor-CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor-CU and the IAB-node DU. The well-known User Datagram Protocol (UDP) is a transport layer protocol providing a best effort datagram service and fit to be used with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor-CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor-CU and the IAB-node DU as defined in 3GPP TS 38.401.

The transport between the IAB-donor-DU and the IAB-donor-CU also uses an IP transport Layer over various media, like for example wires or optical fiber when the IAB-donor-CU is remote from the IAB-donor-DU, or locally in a virtual instantiation of the IAB-donor-CU and the IAB-donor-DU on the same physical machine. IAB-specific transport between IAB-donor-CU and IAB-donor-DU is specified in 3GPP TS 38.401.

L1 and L2 on the Figure stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

In a downstream direction, upper layer packets are encapsulated by the BAP sublayer at the IAB-donor-DU, thus forming BAP packets or data units. The BAP packets are routed by the BAP sublayer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended to a UE).

In upstream direction, upper layer packets are encapsulated by the BAP sublayer at an initiator IAB-node (which may be an access IAB-node should the upper layer packets come from a UE), thus forming BAP packets or data units or data packets. The BAP packets are routed by the BAP sublayer (and corresponding BAP entities in the IAB-DU and IAB-MT) of the intermediate IAB-nodes, if any. The BAP packets are finally de-encapsulated by the BAP sublayer at the IAB-donor-DU.

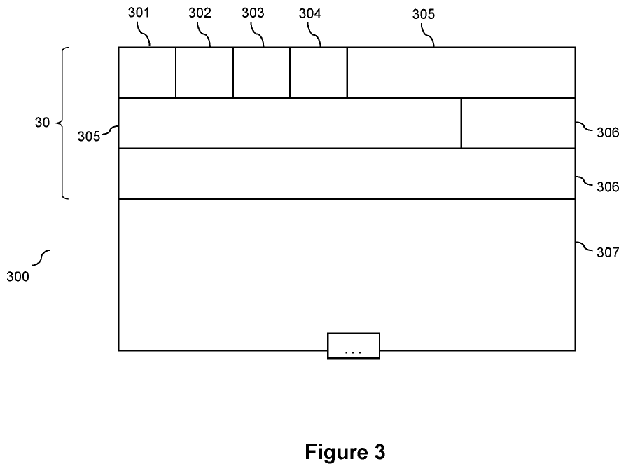

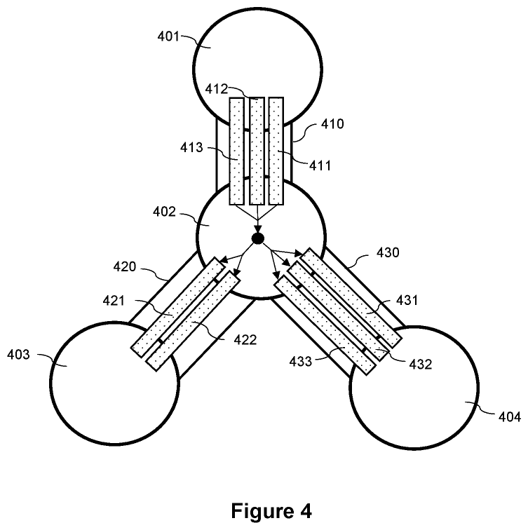

On the BAP sublayer, packets are routed based on a BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS 38.340 version 16.3.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor-DU for the BAP packet. For the purpose of routing, each IAB-node and IAB-donor-DU is configured (by IAB-donor-CU) with a designated and unique BAP address.

Field 306 carries a path ID identifying the routing BAP path the BAP packet should follow to this destination in the IAB topology. For the purpose of routing, the BAP paths, including their path ID, are configured (by IAB-donor-CU) in the IAB-nodes.

The BAP header is added to the packet when it arrives from upper layers to the BAP sublayer, and it is stripped off by the BAP sublayer when it has reached its destination node. The selection of the packet's BAP routing ID is configured by the IAB-donor-CU.

For instance, when the BAP packet is generated by a node, i.e. either by the IAB-donor-DU for downstream transmission or by an initiator IAB-node for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these tables defining the BAP paths (hence the routing strategy and the configuration of the IAB-nodes given the IAB network topology) are usually defined by the IAB-donor-CU and transmitted to the IAB-nodes to configure them.

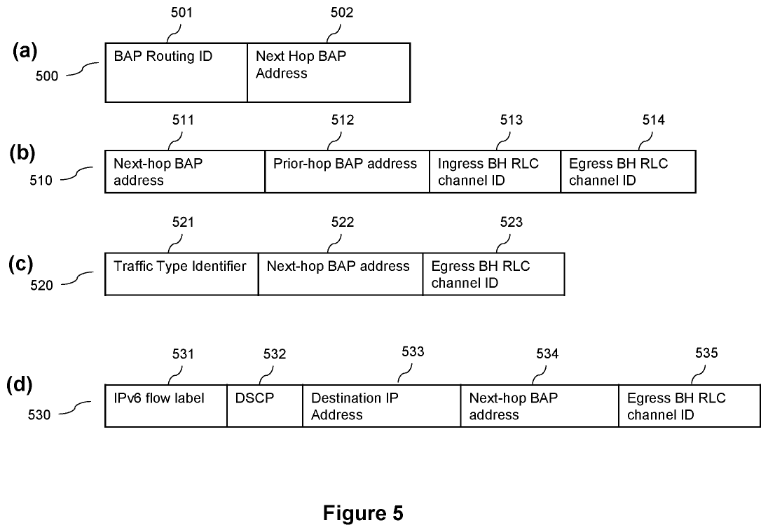

A usage of these tables (and other tables) to perform the routing is described below with reference to FIG. 5.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS 38.322. The MAC (Media Access Channel) protocol sublayer is responsible for selecting available transmission formats for the user data and for the mapping of logical channels to the transport channels. The MAC also handles a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, and TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS 38.323.

SDAP sublayer 220 for the User Plane handles the Quality of Service. It is described in TS38.324. On the UE side, the SDAP sublayer exchanges the payload data with the user's application (voice, video, etc.—not shown in the Figure). On the IAB-donor-CU side, the SDAP sublayer exchanges the data with the Core Network 110 (Internet traffic, Cloud, etc.).

RRC sublayer 220 for the Control Plane handles the configuration of the protocol entities of the User Plane protocol stack. It is described in TS 38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v16.4.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the JAB node, as well as similar information for the IAB-node. AMF is only responsible for handling connection and mobility management tasks.

The IAB-MT establishes Signalling Radio Bearers SRBs (bearers carrying RRC and NAS messages) with the IAB-donor-CU. These SRBs are transported between the IAB-MT and its parent node(s) over NR-Uu interface(s).

FIG. 4 illustrates a routing management in an IAB network. The routing management at an IAB-node acting as relay is based on a BAP routing configuration and seeks to determine, from one BH RLC channel of an ingress link or backhaul link over which a BAP packet is received, one BH RLC channel of one egress link or backhaul link for forwarding the received BAP packet.

A BAP routing configuration may be set manually in each IAB-node of the IAB network. Preferably, the BAP routing configurations are built and can be updated over time by the IAB-donor-CU and transmitted by same via F1AP signalling to the IAB-nodes during their initial configuration and the life of the JAB network. As mentioned above, the BAP routing configurations may be built by IAB-donor-CU based on the IAB network topology and its evolution over time (e.g. should some radio links disappear or recover or their link quality changes).

The BAP routing configuration of the IAB-node comprises various routing tables, four of which are shown in FIG. 5.

FIG. 5a schematically shows an entry 500 of the Backhaul Routing Configuration table as defined in 3GPP TS 38.300, V16.4.0, section 6.11.3 for the BAP sublayer. It is used by the IAB-node to select the egress link to forward or transmit a BAP packet or PDU (Protocol Data Unit).

Field 501 defines a BAP Routing ID (concatenation of the DESTINATION and PATH fields mentioned above) while field 502 specifies the next-hop BAP Address, i.e. the BAP address of the next IAB-node along the path corresponding to the Routing ID 501. The Next Hop BAP address 502 thus identifies an egress link to forward or transmit the BAP packet.

There may be several entries in the Backhaul Routing Configuration table with the same destination BAP address but with different Path IDs and next-hop BAP Addresses in the information element 502. The first entry may provide the default next-hop BAP Address corresponding to the default path to reach the destination, and the other entries with the same destination BAP address relate to back-up redundant paths to be selected when the default link is not available, e.g. because of radio link failure (RLF).

FIG. 5b schematically shows an entry 510 of the BH RLC channel mapping configuration table as defined in 3GPP TS 38.300, section 6.11.3 and/or 3GPP TS 38.340, V16.3.0, section 5.2.1.4.1, for the BAP sublayer. It is used by the IAB-node acting as a relay to identify the Backhaul (BH) RLC channel where to forward a BAP packet or PDU over the egress link previously selected using the Backhaul Routing Configuration table.

Information Element (IE) 511 stores a next-hop BAP address as defined previously and usually obtained from the Backhaul Routing Configuration table; IE 512 stores a prior-hop BAP address, i.e. the BAP address of the previous IAB-node from which the BAP packet to route arrives; IE 513 specifies an ingress RLC channel ID, i.e. the identifier of an RLC channel over which the BAP packet to route is received; and IE 514 stores an egress RLC channel ID providing the RLC channel the IAB-node will use to forward the BAP packet.

Note that for BH RLC channels in downstream direction (parent to child direction, e.g. IAB-node 402 towards IAB-node 403 in FIG. 4), the BH RLC channel ID is included in the F1AP configuration of the BH RLC channel. For BH RLC channels in upstream direction (child to parent direction, e.g. IAB-node 402 towards IAB-node 401), the BH RLC channel ID is included in the RRC configuration of the corresponding logical channel.

FIGS. 5c and 5d illustrates the equivalents to the BH RLC channel mapping configuration table for the IAB-node that does not act as intermediate IAB relaying entities. They are defined in 3GPP TS 38.340, sections 5.2.1.4.2 and section 5.2.1.4.3.

The table in FIG. 5c is called Uplink Traffic to BH RLC Channel Mapping Configuration table, 520. It is used by an initiator IAB-node (not the IAB-donor-DU) having built BAP packets or PDUs from BAP SDUs (Service Data Unit) received from upper layers, to identify the Backhaul (BH) RLC channel to transmit these packets in upstream direction over the egress link previously selected using the Backhaul Routing Configuration table described in FIG. 5a.

IE 521 specifies a Traffic Type Identifier for the SDUs received from the upper layers, IE 522 indicates a next-hop BAP address as defined previously and usually obtained from the Backhaul Routing Configuration table, and IE 523 specifies an egress BH RLC channel providing the RLC channel the IAB-node will use to transmit the BAP packet.

The table in FIG. 5d is called Downlink Traffic to BH RLC Channel Mapping Configuration table 530. It is used by the IAB-donor-DU having built BAP packets or PDUs from BAP SDUs (Service Data Unit) received from upper layers, to identify the Backhaul (BH) RLC channel to transmit these BAP packets in downstream direction over the egress link previously selected using the Backhaul Routing Configuration table.

IE 531 is an IPv6 flow label used to classify IPv6 flows, IE 532 specifies a DSCP (Differentiated Services Code Point) usually indicated in the IPv6 header of the packets, IE 533 indicates a destination IP Address, IE 534 indicates a next-hop BAP Address as defined above, and IE 535 defines an egress BH RLC channel ID providing the RLC channel the IAB-node will use to transmit the BAP packet.

The tables of FIGS. 5b, 5c and 5d may be composed of several rows (entries), each row/entry including the IEs shown in the respective Figures.

Next-hop BAP address and egress link are synonymous because they designate the same portion (radio link) of the IAB network between the current IAB-node and the next IAB-node having the next-hop BAP address. Consequently, they can be used interchangeably to designate such IAB network radio link.

As a result of all the tables configured in the IAB-nodes and more particularly the Routing IDs of IEs 501, multiple BAP paths are defined through multiple IAB-nodes.

Back to FIG. 4, the routing of a BAP packet by the BAP sublayer of IAB-node 402 uses the BAP routing ID 305+306 of a BAP packet. The BAP address (DESTINATION path 305) is used for the purpose of:

1) determining whether the BAP packet has reached the destination node, i.e. IAB-node or IAB-donor-DU, on BAP sublayer. The BAP packet has reached its destination node if the BAP address 305 in the packet's BAP header matches the BAP address configured either via RRC on the IAB-node or via F1AP on the IAB-donor-DU.

2) determining the next-hop IAB-node for the BAP packet that has not reached its destination. This applies to BAP packets arriving from a prior-hop IAB-node over the BAP sublayer or arriving from upper layers.

For packets arriving from a prior-hop IAB-node or from upper layers, the determination of the next-hop IAB-node is based on the entries of the Backhaul Routing Configuration table 500.

The IAB-node 402 resolves the next-hop BAP address 502 to a physical backhaul link, being either link 420 or link 430. To that end, it seeks the entry in the table 500 having field 501 matching the BAP Routing ID 305+306 of the BAP packet. Corresponding field 502 provides the next-hop BAP address.

The Backhaul Routing Configuration table 500 may have multiple entries with different BAP Routing IDs but with the same destination BAP address (meaning the BAP Path IDs are different). These entries may correspond to the same or different egress BH links. In case, the BH link matching the BAP Routing ID of the BAP packet experiences a radio link failure (RLF), the IAB-node may select another egress BH link (next-hop BAP address) based on routing entries with the same destination BAP address, i.e. by disregarding the BAP path ID. In this manner, a BAP packet can be delivered via an alternative path in case the indicated path is not available.

For instance, in case BH link 420 experiences a radio link failure, IAB-node 402 may select another BAP routing ID having the same destination BAP address but involving BH link 430 instead.

Next, the IAB-node 402 derives the egress BH RLC channel of the selected egress BH link, over which the BAP packet is to be transmitted or forwarded. To that end, the IAB-node 402 uses the BH RLC channel mapping configuration table or Uplink Traffic to BH RLC Channel Mapping Configuration table or Downlink Traffic to BH RLC Channel Mapping Configuration table depending on its role (intermediate relay IAB-node, initiator IAB-node or IAB-donor-DU transmitting in uplink or downlink direction).

For instance, for an intermediate relaying IAB-node, IEs 511, 512, 513 are the inputs and IE 514 is the output of the BH RLC channel look-up process: IAB-node 402 routes the incoming BAP packets received from the ingress BH RLC channel ID 513, belonging to the ingress BH link identified by the prior-hop BAP address 512, to the egress BH RLC channel ID 514, belonging to the egress BH link previously selected and now identified by the next-hop BAP address 511.

For an initiator IAB-node wishing to transmit a BAP packet in the upstream direction to the IAB-donor, IEs 521, 522 are the inputs and IE 523 is the output of the BH RLC channel look-up process: the IAB-node 402 selects the egress BH RLC Channel 523 corresponding to the table 520 entry where the Traffic Type Identifier 521 matches the traffic type of the original BAP SDU, and where the next-hop BAP address 522 matches the next-hop BAP address previously selected with the Backhaul Routing Configuration table. This applies for BAP SDUs in the control plane (non F1-U packets), as well as for BAP SDUs in the user plane (F1-U packets). The Traffic Type Identifier 521 shall correspond to the destination IP address and TEID (Tunnel End Point Identifier) of the BAP SDUs.

For an IAB-donor-DU wishing to transmit a BAP packet in the downstream direction to a destination IAB-node or an UE, IEs 531, 532, 533, 534 are the inputs and IE 535 is the output of the BH RLC channel look-up process: the IAB-donor-DU selects the egress BH RLC Channel 535 corresponding to the table 530 entry matching the Destination IP address 533, the IPv6 Flow Label 531 (only for BAP SDU encapsulating an IPv6 packet), and the Differentiated Services Code Point (DSCP) 532 of the original BAP SDU, and where the next-hop BAP address 534 matches the next-hop BAP address previously selected with the Backhaul Routing Configuration table. This applies for BAP SDUs in the control plane (non F1-U packets), as well as for BAP SDUs in the user plane (F1-U packets). If there is no matching entry, the selection of one egress BH RLC channel ID is up to implementation.

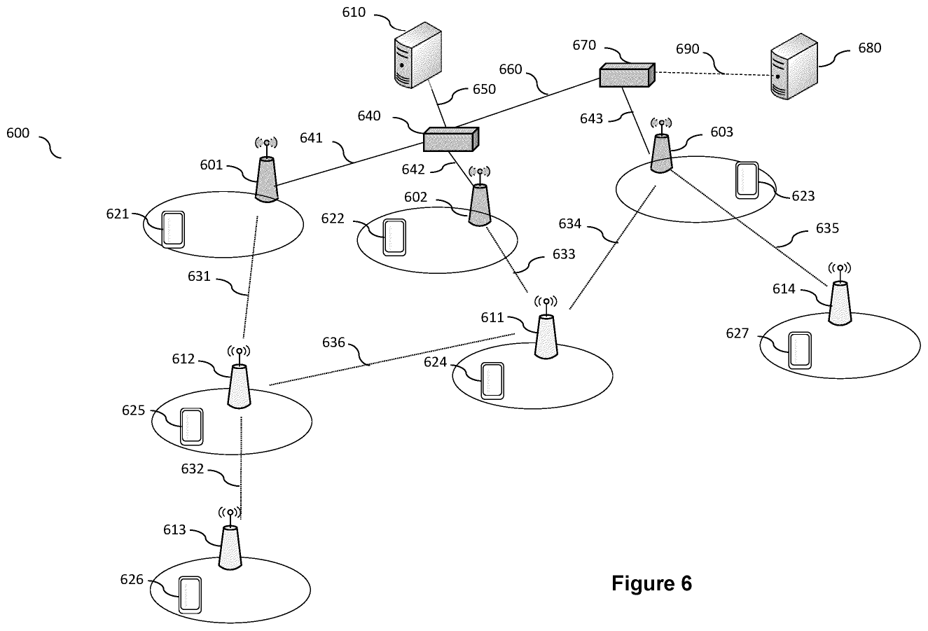

FIG. 6 illustrates an example topology of an IAB network arrangement in which embodiments and examples of embodiments of the present invention may be implemented so as to provide network path diversity through several IAB-donor-DUs. In one example implementation, the BH radio links are operated over the millimeter wave frequency band (i.e. above 30 GHz), which is highly sensitive to radio channel disturbance.

IAB topology 600 includes IAB-donor-CU 610, a plurality of IAB-donor-DU 601, 602, 603, and a plurality of IAB-nodes 611, 612, 613, 614, similar to IAB-nodes 121 and 122.

A wired backhaul IP network interconnects the IAB-donor-CU 610, and the IAB-donor-DUs 601, 602, 603, through the routers 640 and 670, and through the links 641, 642, 643, 650, and 660. For instance, these wired links consist of optical fiber cables. Each of the the IAB-donor-DUs 601, 602, 603 is assigned to one of one or more groups. For example, the groups may be different IP subnetworks of the IP backhaul network between the IAB-donor-DUs 601, 602, 603, and the IAB-donor-CU 610. In the example of FIG. 6, it is assumed that IAB-donor-DUs 601 and 602 belong or are assigned to a first IP subnetwork (e.g. first IP domain) and that IAB-donor-DU 603 belongs or is assigned to a second IP subnetwork (e.g. second IP domain). Besides, it is assumed that the router 640 will not apply a filter to the packets with a source IP address belonging to the first IP domain, and that router 670 will not apply a filter to the packets with a source IP address belonging to the second IP domain.

IAB-node 612 is connected to the parent IAB-donor-DU 601 through BH link 631, to the parent IAB-node 611 through BH link 636, and to the child IAB-node 613 through BH link 632. IAB-node 611 is connected to the parent IAB-donor-DU 602 through BH link 633 and to the parent IAB-donor-DU 603 through BH link 634. IAB-node 614 is connected to the parent IAB-donor-DU 603 through BH link 635.

As IAB-donor-DUs 601, 602, 603, and IAB-nodes 611, 612, 613, 614 are respectively serving UEs 621, 622, 623, 624, 625, 626, and 627, they also act as access IAB-nodes for the respective UEs.

Redundant paths may exist between pairs of IAB-nodes, for instance, regarding downstream paths from IAB-donor-CU 610 to IAB-node 613, a first default BAP path via IAB-donor-DU 601 and IAB-node 612, a second BAP path via IAB-donor-DU 602, IAB-nodes 611, and 612, and a third BAP path via IAB-donor-DU 603, IAB-nodes 611, and 612.

Symmetrically, there are also three upstream paths involving the same devices from IAB-node 613 to IAB-donor-CU 610.

Another possible IAB topology is represented in this figure when considering the presence of a second IAB-donor-CU 680 connected to the router 670 through the wired link 690. This is the case where several IAB networks are deployed by the operator and each IAB network is managed by a single IAB-donor-CU. For instance, a first IAB network composed of IAB-donor DUs 601, 602, and IAB-nodes 611, 612, 613, is managed by the IAB-donor-CU 610, while a second IAB network composed of IAB-donor DU 603 and IAB-node 614 is managed by the IAB-donor-CU 680. Due to the dual connectivity of child IAB node 611 with two parent nodes 602 and 603, the IAB-node 611 appears as a boundary node creating a junction between the two IAB networks. Thus, assuming that the operator enables the communication between the two IAB-donor-CUs 610 and 680, and makes sure that there will be no BAP address conflict (i.e. an IAB-node of the first IAB network will not have the same BAP address as an IAB-node of the second IAB network), then it is possible to consider the same paths between IAB-donor-CU 610 and IAB-node 613 as for the case of a single IAB network managed by the IAB-donor-CU 610.

For the exemplary description below, we consider the following upstream BAP paths:
PATH 1, associated with BAP Routing ID 1, from IAB-node 613 to IAB-donor-DU 601 via IAB-node 612, and going through BH radio links 632 and 631;
PATH 2, associated with BAP Routing ID 2, from IAB-node 613 to IAB-donor-DU 602 via IAB-nodes 612, 611, and going through BH radio links 632, 636, and 633;
PATH 3, associated with BAP Routing ID 3, from IAB-node 613 to IAB-donor-DU 603 via IAB-nodes 612, 611, and going through BH radio links 632, 636, and 634.

BH radio link 631 between IAB-node 612 and IAB-donor-DU 601 may experience radio link deficiency due to some unexpected interference or shadowing phenomena, for example radio link failure, RLF. Thus, due to RLF the BAP path PATH 1 may become unavailable, while PATH 2 and PATH 3 are still operational. The IAB-node 612 may decide, if possible, to re-route the BAP PDUs with Routing ID 1 through an alternative path. Also, the link 631 may be congested due to an excessive data traffic, and the IAB-node 612 may decide to re-route some BAP PDUs with Routing ID 1 through an alternative path in order to mitigate such congestion.

The processes of re-routing are now described according to some embodiments of the present invention.

According to a first embodiment of the invention, each donor DU is assigned a unique address, such as a BAP address, and each donor DU in the IAB network is assigned to one of one or more groups and an unique group identifier is assigned to each group of the one or more groups such that each of the donor DUs in a group is associated with the group identifier assigned to the group. In an example arrangement of the first embodiment of the invention, the groups may be different IP subnetworks of the IP backhaul network between the donor DUs (such as IAB-donor-DUs 601, 602, 603) and the donor CU (such as IAB-donor-CU 610).

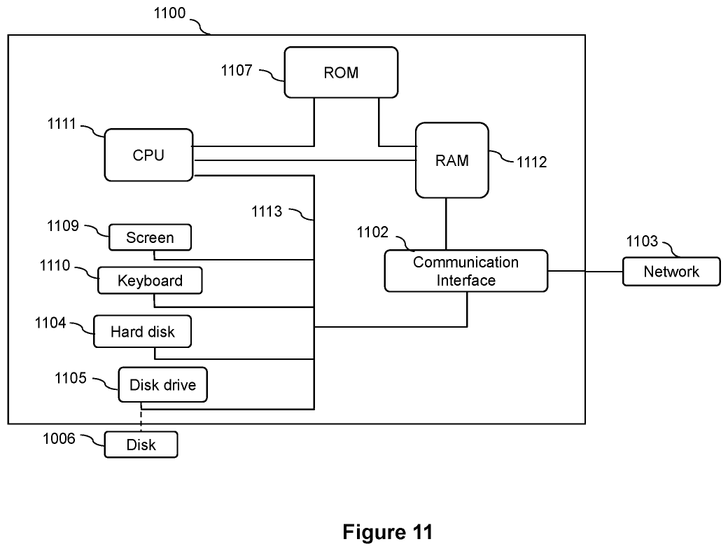

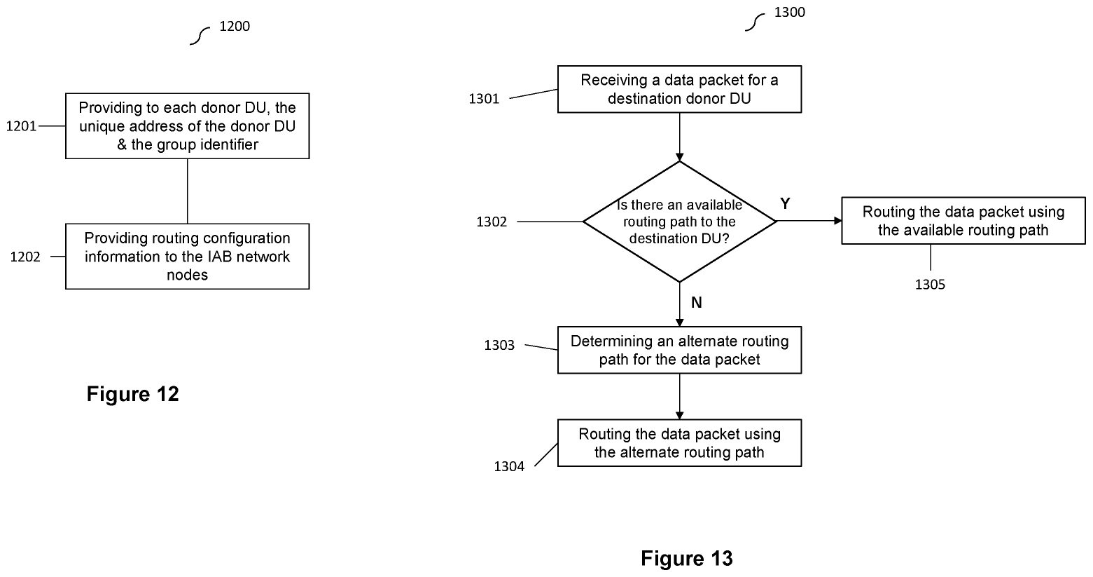

FIG. 12 shows steps of a method 1200, performed at a donor CU, for managing routing of data packets over wireless backhaul links in an IAB network (for example, having a topology such as that shown in FIG. 6) comprising a donor network node and a plurality of IAB network nodes (such as IAB-nodes 611, 612, 613), the donor network node comprising a donor CU (such as IAB-donor-CU 610) and a plurality of donor DUs (such as IAB-donor-DUs 601, 602, 603) in accordance with the first embodiment of the invention having the group identifier. The donor CU may be implemented in a communication device 1100 as shown in FIG. 11 below with the method as shown in FIG. 12 being performed by the central processing unit 1111.

Briefly, in step 1201, the donor CU provides to each donor DU, the unique address of the donor DU. The donor CU may also provide the group identifier associated with the donor DU. In Step 1202, the donor CU provides routing configuration information to the plurality of IAB network nodes. The routing configuration information includes the unique addresses of the donor DUs corresponding to destination donor DUs for data packets to be transmitted to the donor CU, path identifiers identifying routing paths to the destination donor DUs, and the group identifiers associated with the destination donor DUs. Although the steps 1201, 1202 are shown as two separate steps with step 1202 following 1201, the donor CU may configure the IAB network nodes and each donor DU in any order or simultaneously at the same time. The donor CU may receive a data packet for a destination donor DU from the destination donor DU or a different donor DU in the same group as the destination donor DU with the same associated group identifier.

FIG. 13 shows steps of a method 1300, performed at an IAB network node, for routing data packets over one or more wireless backhaul links in an IAB network (for example, having a topology such as that shown in FIG. 6) comprising a donor network node and a plurality of JAB network nodes (such as IAB-nodes 611, 612, 613), the donor network node comprising a donor CU (such as IAB-donor-CU 610) and a plurality of donor DUs (such as IAB-donor-DUs 601, 602, 603) in accordance with the first embodiment of the invention having the group identifier. The IAB network node is configured with routing configuration information including a unique address of at least one donor DU corresponding to at least one destination donor DU for data packets to be transmitted by the JAB network node, at least one path identifier identifying at least one routing path to the at least one destination donor DU, the unique address of a donor DU or IAB network node of the IAB network that is a next node in the at least one routing path and the group identifier associated with the at least one destination donor DU. The IAB network node may be implemented in a communication device 1100 as shown in FIG. 11 below with the method as shown in FIG. 13 being performed by the central processing unit 1111.

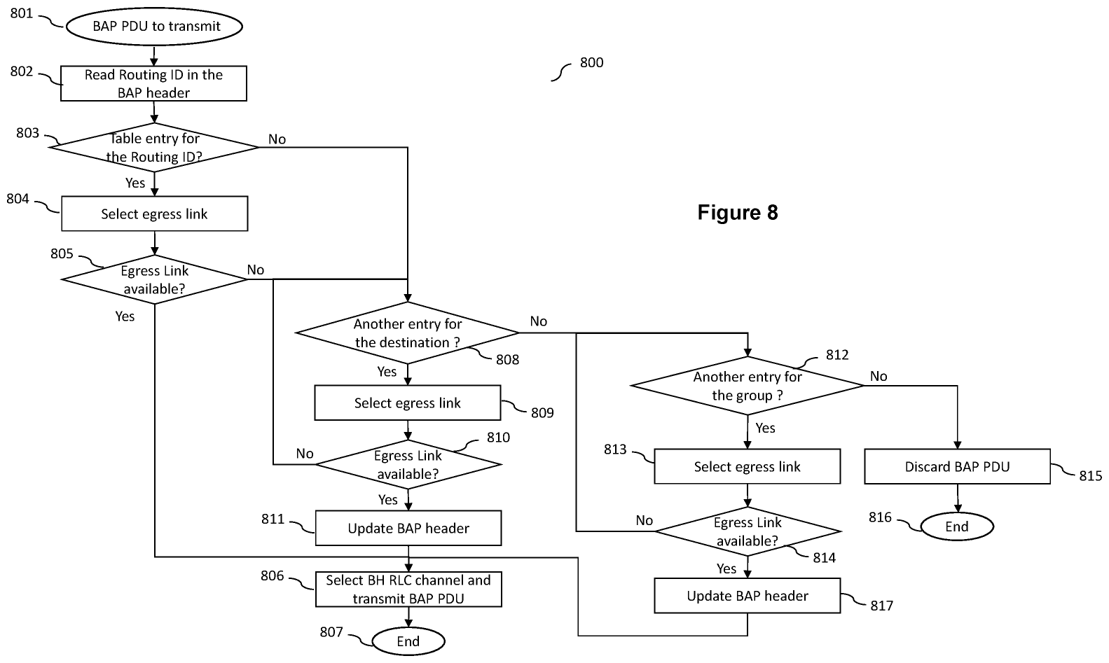

Briefly, in step 1301, the JAB network node receives a data packet for a destination donor DU. The data packet includes (e.g. in a header) the unique address of the destination donor DU for the data packet and a path identifier identifying the routing path to the destination donor DU. The IAB network then determines, at step 1302, whether there is an available routing path to the destination donor DU based on the unique address of the destination donor DU and the path identifier included in the data packet and the routing configuration information, and based on the unique address of the destination donor DU included in the data packet and the routing configuration information. If it is determined that there is an available routing path, the data packet is routed using the available routing path at step 1305. When no available routing path is determined, the IAB network node determines, at step 1303, an alternate routing path for the data packet for the destination donor DU using the routing configuration information and based on the unique address of the destination donor DU and the group identifier associated with the destination donor DU. The alternate routing path is to a different destination donor DU in the same group as the destination donor DU with the same group identifier. At step 1304, the IAB network node routes the data packet using the alternate routing path. The description below (in particular with respect to FIG. 8) provides more details regarding how the IAB network node handles the routing of data packets.

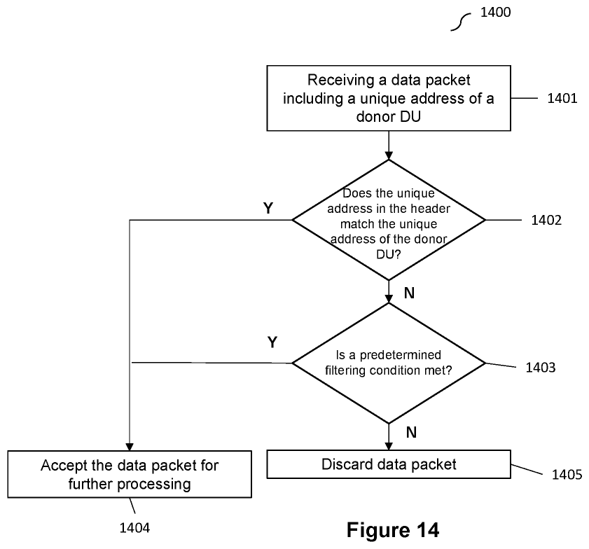

FIG. 14 shows steps of a method 1400, performed at a donor DU, for processing data packets in a wireless IAB network (for example, having a topology such as that shown in FIG. 6) comprising a donor network node and a plurality of IAB network nodes (such as IAB-nodes 611, 612, 613), the donor network node comprising a donor CU (such as IAB-donor-CU 610) and a plurality of donor DUs (such as IAB-donor-DUs 601, 602, 603) in accordance with the first embodiment of the invention having the group identifier. The donor DU is configured with configuration information including the unique address of the donor DU and the group identifier associated with the donor DU. The IAB node may be implemented in a communication device 1100 as shown in FIG. 11 below with the method as shown in FIG. 14 being performed by the central processing unit 1111.

Briefly, in step 1401, the donor DU receives a data packet which includes (e.g. in a header) the unique address of a donor DU corresponding to a destination donor DU for the data packet. At step 1402, the donor DU determines whether the unique address in the header matches the unique address of the donor DU in the configuration information. When the unique addresses do not match (No branch at step 1402), the donor DU then determines at step 1403 whether a predetermined filtering condition is met. If the predetermined filtering condition is not met (No branch at step 1403), the data packet is discarded at step 1405. When the predetermined filtering condition is met (Yes branch at step 1403), the donor DU accepts, at step 1404, the received data packet for further processing. In an example when the group identifier comprises a group address, the donor DU (at step 1402) determines whether the unique address or the group address in the header matches the unique address or the group address of the donor DU in the received routing configuration information and when the unique addresses or the group addresses match, the donor DU accepts the received data packet for further processing.

The routing configuration information provided by the donor CU to the donor DU may include a routing configuration table.

In an example arrangement of the first embodiment, the routing configuration table includes at least one entry, each entry having a destination address field for the unique address of a destination donor DU, a path identifier field for the path identifier of a routing path to the destination donor DU, a group identifier field for the group identifier associated with the destination donor DU. The routing configuration table may further comprise a next-hop address field for the unique address of a donor DU or IAB network node of the IAB network that is next in the routing path.

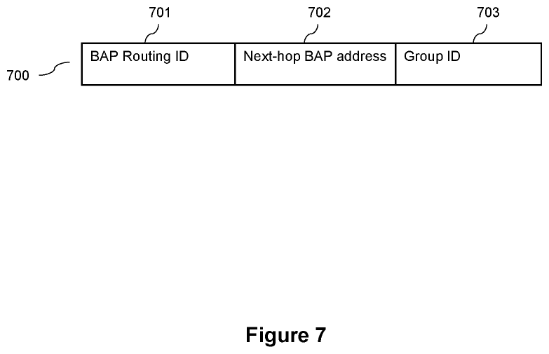

FIG. 7 illustrates an example augmented BH routing configuration table or routing configuration table 700 according to the first embodiment of the invention. This routing configuration table 700 corresponds to table 500 described in the FIG. 5a, with the same fields 701 for the BAP Routing ID (including the destination address field and the path identifier field) and 702 for the next hop BAP address (i.e. the egress link), and an additional field or group identifier field 703 for a parameter Group ID. As discussed above, each donor DU in the IAB network is assigned to one of one or more groups and an unique group identifier is assigned to each group of the one or more groups such that each of the donor DUs in a group is associated with the group identifier assigned to the group. The group identifier field 703 is for a group identifier (Group ID) assigned to the group to which the destination donor DU is assigned to, the destination donor DU being identified by the unique BAP address in the BAP Routing ID in the field 701. In an example arrangement when the assigned groups may be different IP subnetworks of the IP backhaul network between the IAB-donor-DUs 601, 602, 603, and the IAB-donor-CU 610, a Group ID identifies a group of IAB-Donor-DUs belonging to the same IP subnetwork in the wired backhaul connecting IAB-donor-CUs and IAB-donor-DUs. It also means that packets re-routing between the IAB-donor-DUs belonging to the same group may be performed according to the IP filtering.

The Group ID field 703 is set to a default value (e.g. 0x0) when the destination BAP address in the field BAP Routing ID 701 refers to an IAB-node (i.e. it is not an IAB-donor-DU).

The Group ID field 703 may be represented with few bits. One bit may even be sufficient assuming there is no IP filtering in the wired backhaul. In this case, the purpose of the Group ID field 703 is to identify BAP Routing ID associated to an IAB-donor-DU.

In another example in accordance with the first embodiment, the Group ID field 703 may be merged within the destination BAP address, which is part of the BAP Routing ID field 701. For instance, several bits in the destination BAP address may be reserved for the Group ID parameter or group identifier. In other words, the routing configuration table may include a destination address field for the unique address of a destination donor DU and the group identifier associated with the destination donor DU, and a path identifier field for the path identifier of a path or routing path to the destination donor DU.

Group IDs may be assigned by the operator and configured at IAB-nodes by the IAB-Donor-CU at the same time as the other fields 701 and 702.

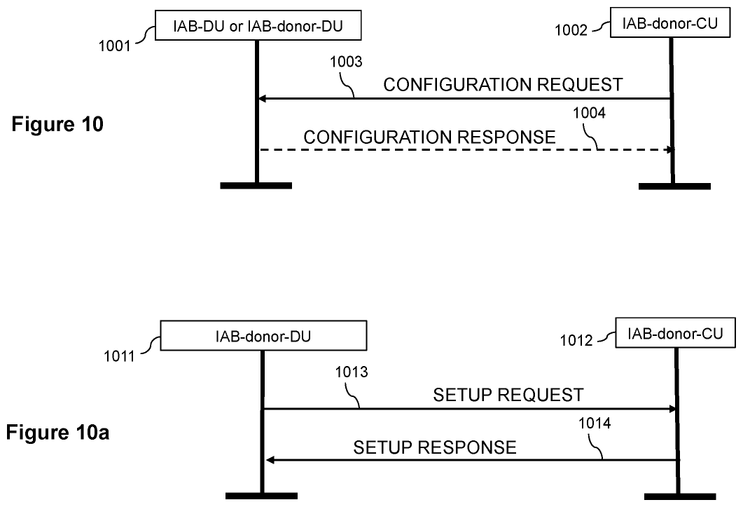

FIG. 10 illustrates an exemplary message flow for providing routing configuration information to the donor DUs (and IAB nodes) according to embodiments (including the first and second embodiments) and examples of the invention. For example, the exemplary message flow of FIG. 10 may configure a routing configuration table, such as the BH routing configuration table 700 at an IAB-node and an IAB-donor-DU by the IAB-donor-CU, according to embodiments of the invention.

The IAB-donor-CU 1002 initiates the procedure by sending a CONFIGURATION REQUEST message 1003 to an IAB-DU or an IAB-donor-DU 1001 to configure the table. The IAB-DU or the IAB-donor-DU 1001 may reply to the IAB-donor-CU 1002 with a CONFIGURATION RESPONSE message 1004.

The CONFIGURATION REQUEST message 1003 may include the whole routing configuration table. Alternatively, the message may only include the entries of the routing configuration table 700 that are to be updated or added. Still alternatively, the message may only include information for updating entries already stored in the IAB-DU or the IAB-donor-DU 901 and/or for adding new entries.

Various message types may be used for the CONFIGURATION REQUEST and RESPONSE messages.

In one embodiment, the CONFIGURATION REQUEST message 1003 is a BAP MAPPING CONFIGURATION message and the CONFIGURATION RESPONSE message 1004 is a BAP MAPPING CONFIGURATION ACKNOWLEDGE message, as described in 3GPP TS 38.473 v16.4.0, sections 9.2.9.1 and 9.2.9.2.

The additional Group ID field 703 of the augmented Backhaul Routing Configuration table 700 may be declared as optional IE in the BH Routing Information Added List IE of the BAP MAPPING CONFIGURATION message as described in 3GPP TS 38.473 v16.4.0. The corresponding declaration may be as in the following table.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| Transaction ID | M | | 9.3.1.23 | | YES | reject |
| BH Routing | | 0 . . . 1 | | | YES | ignore |
| Information | | | | | | |
| Added List | | | | | | |
| >BH Routing | | 1 . . . | | | EACH | ignore |
| Information | | <maxnoofRoutingEntries> | | | | |
| Added List Item | | | | | | |
| >>BAP Routing | M | | 9.3.1.110 | | — | |
| ID 701 | | | | | | |
| >>Next-Hop | M | | 9.3.1.111 | Indicates the | — | |
| BAP Address | | | | BAP address of | | |
| 702 | | | | the next hop | | |
| | | | | IAB-node or | | |
| | | | | IAB-donor- | | |
| | | | | DU. | | |
| >>Group ID | O | | | | | |
| 703 | | | | | | |
| BH Routing | | 0 . . . 1 | | | YES | ignore |
| Information | | | | | | |
| Removed List | | | | | | |
| >BH Routing | | 1 . . . | | | EACH | ignore |
| Information | | <maxnoofRoutingEntries> | | | | |
| Removed List | | | | | | |
| Item | | | | | | |
| >>BAP Routing | M | | 9.3.1.110 | | — | |
| ID | | | | | | |
| Traffic Mapping | O | | 9.3.1.95 | | YES | ignore |
| Information | | | | | | |

In a variant, the CONFIGURATION REQUEST message 1003 is a UE CONTEXT SETUP REQUEST message and the CONFIGURATION RESPONSE message 1004 is a UE CONTEXT SETUP RESPONSE message, as described in 3GPP TS 38.473 v16.4.0, sections 9.2.2.1 and 9.2.2.2.

In another variant, the CONFIGURATION REQUEST message 1003 is a UE CONTEXT MODIFICATION REQUEST message and the CONFIGURATION RESPONSE message 1004 is a UE CONTEXT MODIFICATION RESPONSE message, as described in 3GPP TS 38.473 v16.4.0, sections 9.2.2.7 and 9.2.2.8.

Using the example of FIG. 6, the BH routing configuration table 700 of IAB-node 612 may include the following entries:

| | | Group |
|---|---|---|
| BAP Routing ID | Next hop BAP address | ID |
| ID 1 (BAP Address IAB-donor- | BAP Address IAB-donor-DU | 0x1 |
| DU 601 + PATH 1) | 601 | |
| ID 2 (BAP Address IAB-donor- | BAP Address IAB-node 611 | 0x1 |
| DU 602 + PATH 2) | | |
| ID 3 (BAP Address IAB-donor- | BAP Address IAB-node 611 | 0x2 |
| DU 603 + PATH 3) | | |

Then, IAB-node 612 has the information that BAP PDUs with BAP Routing ID 1 can be re-routed by selecting the egress link toward IAB-node 611. Indeed, the two first entries are associated to the same Group ID having a non-zero value. It also means that BAP PDUs with BAP Routing ID 2 can be re-routed by selecting the egress link toward IAB-donor-DU 601. In other words, based on the group identifier (Group ID), a data packet for IAB-donor DU 601 can be routed via a first routing path to IAB-donor-DU 601 identified by BAP Routing ID1 and can also be routed via a second routing path to IAB-donor-DU 602 identified by BAP Routing ID2 since the Group ID for ID1 and ID2 is the same 0x1. Similarly based on the Group ID, a data packet for IAB-donor DU 602 can be routed via a first routing path to IAB-donor-DU 602 identified by BAP Routing ID2 and can also be routed via a second routing path to IAB-donor-DU 601 identified by BAP Routing ID1 since the Group ID for ID1 and ID2 is the same 0x1.

The BH routing configuration table 700 of IAB-node 611 may include the following entries:

| | | Group |
|---|---|---|
| BAP Routing ID | Next hop BAP address | ID |
| ID 2 (BAP Address IAB-donor- | BAP Address IAB-donor-DU | 0x1 |
| DU 602 + PATH 2) | 602 | |
| ID 3 (BAP Address IAB-donor- | BAP Address IAB-donor-DU | 0x2 |
| DU 603 + PATH 3) | 603 | |

Then, IAB-node 612 has the information that BAP PDUs with BAP Routing ID 2 or BAP Routing ID 3 cannot be re-routed as there is no other entry with the same Group ID.

FIG. 8 illustrates, using a flowchart 800, an exemplary method to route BAP PDUs in IAB-nodes or IAB-donor-DUs according to embodiments (including the first and second embodiments) and examples of the invention. For instance, a program element executed by the CPU 1111 of FIG. 11 for a BAP entity (DU or MT part) of the BAP sublayer may perform the exemplary method shown in FIG. 11. As the invention concerns upstream transmissions, it is noted that the steps 811 to 814 of the exemplary method for upstream transmissions will be executed in the MT part of an IAB-node.

The process is triggered in step 801 by the reception of a new BAP PDU to transmit from the collocated BAP entity (i.e. from DU part), or when a new BAP PDU to transmit has been locally generated from a BAP SDU received from the upper layers. In step 802, the IAB-node reads the BAP header to extract the BAP Routing ID. In step 803, the BH routing configuration table 700 is read to search for an entry (field 701) matching the extracted BAP Routing ID. In case the entry is found, the egress link is selected in step 804 according to the value of the field 702 in the found entry. In step 805, it is checked whether the selected egress link is available (e.g. no radio link failure detected, no congestion detected). If the link is available, a BH RLC channel is selected at step 806 according to the appropriate table 510, 520, or 530 previously configured by the IAB-donor-CU. The process ends at step 807.

In case there is no entry matching the extracted BAP Routing ID at step 803, or in case the selected egress link is declared not available at step 805, then at step 808, the IAB-node searches for another entry in the BH routing configuration table 700 for which the destination BAP address in the field 701 matches the destination BAP address in the extracted BAP Routing ID. If another entry is found, the egress link is selected in step 809 according to the value of the field 702 of the found entry. In step 810, it is checked whether the selected egress link is available (e.g. no radio link failure detected, no congestion detected). If yes, the BAP header of the BAP PDU may be updated in step 811 to reflect the new backhaul path followed by the BAP PDU. It means that the PATH field 306 of the BAP header may be updated with the Path ID value in the field 701 of the found entry. Finally, the steps 806 and 807 are executed. If the selected egress link is not available at step 810, then another entry is searched in step 808. In case there is no other entry matching the destination BAP address, the IAB-node tries to re-route the BAP PDU according to the Group ID parameter.

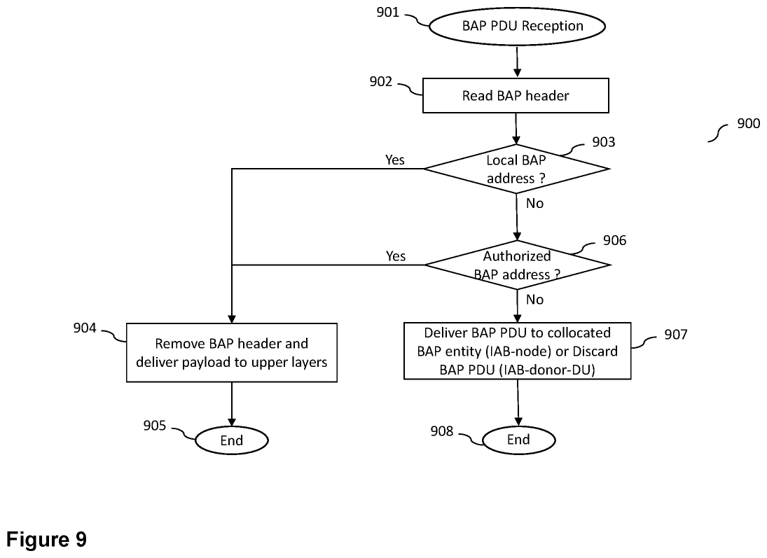

In step 812, the IAB-node searches for another entry in the BH routing configuration table 700 for which the Group ID field 703 is not null and is the same as the Group ID field 703 in the entry matching the extracted BAP Routing ID or matching the destination BAP address in the extracted BAP Routing ID. If another entry is found, it means that the BAP PDU is intended for an IAB-donor-DU and that another different IAB-donor-DU would accept the reception of this BAP PDU re-routed via an alternate routing path to the different IAB-donor-DU with the same group address as the intended IAB-donor-DU. Then, in step 813 the egress link is selected according to the value of the field 702 of the found entry. In step 814, it is checked whether the selected egress link is available (e.g. no radio link failure detected, no congestion detected). If yes, the BAP header of the BAP PDU may be updated in step 817 to reflect the new destination (e.g. the different IAB-donor-DU) and the new backhaul path followed by the BAP PDU. It means that the DESTINATION field 305 and the PATH field 306 of the BAP header may be updated with the BAP Routing ID value in the field 701 of the found entry. Finally, the steps 806 and 807 are executed. The interest of updating the BAP header at this stage is to avoid introducing additional means in the IAB-donor-DU to accept a re-routed BAP PDU with a DESTINATION field 305 in the header that does not match its local BAP address. Furthermore, by updating the BAP header, the routing configuration of intermediate IAB-nodes in the routing path will be coherent with the actual connections (no entry for a destination BAP address without a real path to reach it). However, as discussed below, for example with reference to FIG. 9, instead of updating the BAP header of the BAP PDU in step 817, alternative steps, for example at the donor DU, can be taken to enable the different IAB-donor-DU to accept a re-routed BAP PDU with a DESTINATION field 305 in the header that does not match its local BAP address. With such alternative steps, the updating BAP header step 817 can be omitted.

When no entry is found in step 812, the BAP PDU is discarded in step 815 and the process ends at step 816.

FIG. 9 illustrates, using a flowchart 900, an exemplary method for processing the received data packets or BAP PDUs in IAB-nodes or IAB-donor-DUs according to embodiments (including the first and second embodiments) and examples of the invention. For instance, a program element executed by the CPU 1111 of FIG. 11 for a BAP entity (in IAB-MT, IAB-DU, or IAB-donor-DU) of the BAP sublayer may perform the exemplary method shown in FIG. 9. As the invention concerns upstream transmissions, it is noted that the step 906 of the exemplary method for upstream transmissions will be executed by an IAB-donor-DU.

The process is triggered in step 901 by the reception of a BAP PDU from a backhaul ingress link (e.g. from a IAB-node). In step 902, the BAP header is read to get the destination BAP address from the DESTINATION field 305 of the header. In step 903, the local BAP address of the IAB-node or IAB-donor-DU is compared with destination BAP address. If the local BAP address matches the destination BAP address, the BAP header is removed in the step 904, and the payload section 307 of the BAP PDU is delivered to the upper layers. Otherwise, an additional test is performed in step 906 to check or determine if a predetermined filtering condition is met such that other BAP addresses may be accepted for delivery to upper layers for further processing. In the case of a IAB-donor-DU (donor DU), the further processing may include transmitting the data packet to the IAB-donor-CU (donor CU). This test is necessary in the case of an IAB-donor-DU receiving a BAP PDU re-routed without BAP header update as described in step 817 of FIG. 8. The predetermined filtering condition may include one of: all data packets received at the IAB-donor-DU can be accepted for further processing; or the unique address in the header of the data packet matches a unique address included in a list of unique addresses of acceptable IAB-donor-DUs provided to the IAB-donor-DU by the IAB-donor-CU; or the header of the data packet includes a group identifier (e.g. filtering group identifier) that matches a group identifier provided to the IAB-donor-DU by the IAB-donor-CU. For example, the group identifier included in the header may correspond to the group identifier (Group ID) of the group to which the donor DU is assigned and which group identifier is provided to the IAB-donor-DU by the IAB-donor-CU. The list of unique addresses of acceptable IAB-donor-DUs corresponds to a list of authorised unique addresses. The list may include unique addresses of IAB-donor-DUs belonging to the same group such as the same IP subnetwork. The group identifier may correspond to a group identifier assigned to one or more IAB-donor-DUs belonging to the same group such as the same IP subnetwork. The IAB-donor CU may provide filtering configuration information relating to the predetermined filtering condition to the IAB-donor-DUs to configure the IAB-donor-DUs. For example, the filtering configuration information may include an indication that all unique addresses are authorised, the list of authorised unique addresses or the group identifier. The filtering configuration information may be provided in an Information Element and may be provided to a IAB-donor-DU with the configuration information including the unique address assigned to the IAB-donor-DU. The predetermined filtering condition enables the IAB-donor DU to accept data packets which would otherwise be discarded and without the need to update the header of the data packet as the data packet is routed along alternate routing paths. For BAP implementations, the predetermined filtering condition provides BAP filtering.

For instance, the IAB-donor-CU may configure an IAB-donor-DU to accept and to deliver to upper layers every BAP PDU payloads regardless the destination BAP addresses. According to another example of an embodiment, the IAB-donor-CU may configure an IAB-donor-DU to accept BAP PDUs for a restricted list of authorized BAP addresses. For instance, this list may include the BAP addresses of IAB-donor-DUs belonging to the same IP subnetwork (i.e. for which there will be no IP filtering when the IP packet will be transmitted to the IAB-donor-CU). According to another example of an embodiment where the Group ID is included in the BAP address and the IAB-donor-DU is configured by the IAB-donor-CU with a local Group ID value, the step 906 consists in checking that the Group ID present in the destination BAP address of the BAP PDU matches the local Group ID of IAB-donor-DU. A particular configuration of IAB-donor-DUs to filter BAP addresses may be set through a dedicated Information Element (IE) provided along with the local BAP address.

The FIG. 10a illustrates an exemplary message flow for providing filtering configuration information to a IAB-donor-DU according to embodiments (including the first and second embodiments) and examples of the invention. For example, the exemplary message flow of FIG. 10 may configure the BAP filtering in IAB-donor-DU by the IAB-donor-CU, according to embodiments of the invention.

The IAB-donor-DU 1011 initiates the procedure by sending a SETUP REQUEST message 1013 to the IAB-donor-CU 1012. The IAB-donor-CU 1012 replies to the IAB-donor-DU 1011 with a SETUP RESPONSE message 1014.

The SETUP RESPONSE message 1014 may include an Information Element (IE) describing the filtering policy. For example, the IE may include filtering configuration information that relates to or determines predetermined filtering conditions that must be met for a data packet to be accepted by the IAB-donor-DU.

In one example, the SETUP REQUEST message 1013 is a F1 SETUP REQUEST message and the SETUP RESPONSE message 1014 is a F1 SETUP RESPONSE message, as described in 3GPP TS 38.473 v16.4.0, sections 9.2.1.4 and 9.2.1.5.

The filtering IE may be declared as optional IE and may be present following the existing BAP Address IE.

Back to FIG. 9, when the result of step 906 is positive (i.e. the destination BAP address is authorized for reception), the step 904 is executed to deliver the BAP PDU payload to the upper layers. Otherwise, for an IAB-node, the BAP PDU is delivered to the collocated BAP entity (in IAB-DU or UAB-MT) for routing and transmission as described by the FIG. 8, and for an IAB-donor-DU, the BAP PDU is discarded as there is no collocated BAP entity (the IAB-donor-DU is the last parent in upstream direction).

In the above, details of an example of a first embodiment having a group identifier have been described where the group identifier comprises one or more bits included in a routing configuration table (e.g. in a separate group identifier field or in the destination address field with the unique address of the destination donor DU). In another example in accordance with the invention, the group identifier may be a group address (for example, having the same format as an unique address assigned to a donor DU). In this another example, each of the donor DUs in a group is assigned the same group address such that each donor DU is assigned a unique address and a group address. In such a case, the routing configuration information may comprise a routing configuration table including at least one entry, each entry having a destination address field for the unique address of a destination donor DU or the group address of the destination donor DU, and a path identifier field for the path identifier of a routing path to the destination donor DU. The routing configuration table may further comprise a next-hop address field for the unique address of a donor DU or IAB network node of the IAB network that is next in the routing path. Thus, in the example where the grouping is based on IP subnetworks, all the donor DUs assigned to the same IP subnetwork will have the same group address. It will be appreciated that details described above (e.g. configuring of the donor DU, routing at IAB nodes, etc. described with reference to FIGS. 8, 10, 10a) with respect to the example where the group identifier comprises one or more bits included in a routing configuration table (e.g. in a separate group identifier field or in the destination address field with the unique address of the destination donor DU) may also apply to the example where the group identifier is a group address.

Thus, when a IAB node is an initiator node, the IAB node may generate a data packet for routing to a destination donor DU, wherein the data packet includes a header comprising the unique address or the group address of the destination donor DU. The initiator IAB node may select which address to use based on whether there are any RLF or congestion conditions in any of the routing paths and if there is no condition (e.g. both routing paths are available), based on one routing path being a preferred routing path (e.g. based on QoS, latency, etc.). Identification of preferred routing path(s) may be configured in the IAB nodes by the donor CU.

A data packet for a destination donor-DU can be re-routed to an alternative or different IAB-donor DU in the same group as the destination donor-DU based on a group address in the header of the data packet or based on a group address which corresponds to the unique address in the header of the data packet (e.g. the unique address is mapped to a group address and vice versa) and entries in the routing configuration table. For example, if the IAB node is configured with a routing configuration table having a first entry with the unique address of a first donor DU in the destination address field and a second entry with the group address of a second donor DU in the destination address field, with the second donor DU being in the same group as the first donor DU and so having the same group address as the first donor DU, when the IAB node receives a data packet with a header having the unique address or group address of the first donor DU in the routing ID, the IAB node will be able to identify a first routing path for the data packet to the first donor DU and a second routing path for the data packet to the second donor DU. The IAB node may then select which of the first and second routing paths to use based on whether there are any RLF or congestion conditions in any of the routing paths and if there is no condition (e.g. both routing paths are available), based on one routing path being a preferred routing path (e.g. QoS, latency, etc.). Identification of preferred routing path(s) may be configured in the IAB nodes by the donor CU. See for example FIG. 8 and its accompanying description for additional details for routing and re-routing data packets in an IAB node.

An IAB-donor-DU will accept a data packet when the destination address in the header is the unique address matching the unique address of the IAB-donor-DU or the group address matching the group address of the IAB-donor-DU.

In this another example, an IAB-donor-DU may therefore be configured with an additional local BAP address, i.e. a secondary BAP address in addition to a primary BAP address which corresponds to the unique address assigned to the IAB-donor-DU. This configuration may be achieved through the same procedure described in the FIG. 10a. Actually, this secondary BAP address may be equal for all the IAB-donor-DUs belonging to the same IP subnetwork. This is equivalent to a Group ID having the format of a BAP address. Besides, an IAB-donor-DU will accept the BAP PDUs with a destination BAP address equals to the primary BAP address and the BAP PDUs with a destination BAP address equals to the secondary BAP address. Therefore, an initiator IAB-node generating a BAP PDU may build the BAP header with a BAP Routing ID including the primary or the secondary BAP address of the targeted IAB-donor-DU. In case the secondary BAP address is used, the BAP PDU can be re-routed towards an alternative IAB-donor-DU having the same secondary BAP address.

Using the example of FIG. 6, the BH routing configuration table 500 of IAB-node 612 may include the following entries (with secondary BAP Address IAB-donor-DU 601=secondary BAP Address IAB-donor-DU 602):

| BAP Routing ID | Next hop BAP address |
|---|---|
| ID 1 (primary BAP Address | Primary BAP Address IAB-donor-DU |
| IAB-donor-DU 601 + PATH 1) | 601 |
| ID 2 (primary BAP Address | BAP Address IAB-node 611 |
| IAB-donor-DU 602 + PATH 2) | |
| ID 3 (primary BAP Address | BAP Address IAB-node 611 |
| IAB-donor-DU 603 + PATH 3) | |
| ID 4 (secondary BAP Address | Primary BAP Address IAB-donor-DU |
| IAB-donor-DU 601 + PATH 1) | 601 |
| ID 5 (secondary BAP Address | BAP Address IAB-node 611 |
| IAB-donor-DU 601 + PATH 2) | |

The BH routing configuration table 500 of IAB-node 611 may include the following entries:

| BAP Routing ID | Next hop BAP address |
|---|---|
| ID 2 (primary BAP Address | Primary BAP Address IAB-donor-DU |
| IAB-donor-DU 602 + PATH 2) | 602 |
| ID 3 (primary BAP Address | Primary BAP Address IAB-donor-DU |
| IAB-donor-DU 603 + PATH 3) | 603 |
| ID 5 (secondary BAP Address | Primary BAP Address IAB-donor-DU |
| IAB-donor-DU 601 + PATH 2) | 602 |

According to a second embodiment of the invention, routing configuration information is provided by the donor CU and comprises a routing configuration table including at least one entry, each entry including a destination address field for the unique address of a donor DU corresponding to a destination donor DU for receiving data packets to be transmitted to the donor CU, and a path identifier field for a path identifier of a routing path for the destination donor DU. At least one entry in the routing configuration table includes the unique address of a first donor DU of the plurality of donor DUs as the destination donor DU in the destination address field, and a path identifier for a routing path to a second donor DU of the plurality of donor DUs, the second donor DU being different to the first donor DU. With such an entry in the routing configuration table, data packets for the first donor DU can be routed to the donor CU via the second donor DU. In other words, at least one additional entry (e.g. additional to an entry which includes the unique address of a first donor DU of the plurality of donor DUs as the destination donor DU in the destination address field, and a path identifier for a routing path to the first donor DU of the plurality of donor DUs) is added to the routing configuration table to provide an alternate routing path for a data packet for a destination donor DU to a different or alternative donor DU. Each entry of the routing configuration table may further include a next-hop address field for the unique address of a donor DU or IAB network node of the IAB network that is next in the routing path.

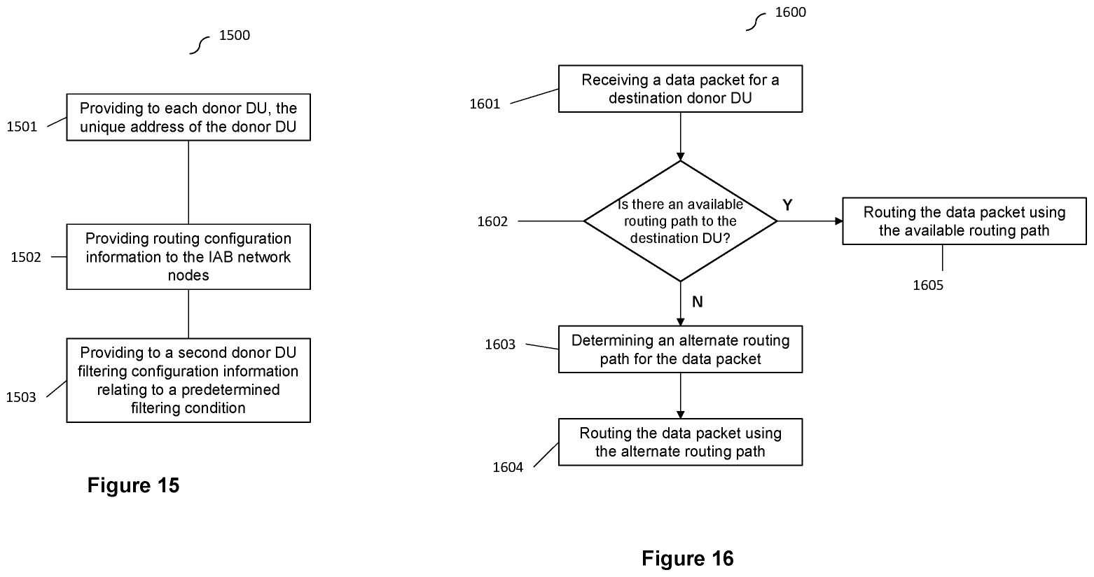

FIG. 15 shows steps of a method 1500, performed at a donor CU, for managing routing of data packets over wireless backhaul links in an IAB network (for example, having a topology such as that shown in FIG. 6) comprising a donor network node and a plurality of IAB network nodes (such as IAB-nodes 611, 612, 613), the donor network node comprising a donor CU (such as IAB-donor-CU 610) and a plurality of donor DUs (such as IAB-donor-DUs 601, 602, 603) in accordance with the second embodiment of the invention. The donor CU may be implemented in a communication device 1100 as shown in FIG. 11 below with the method as shown in FIG. 15 being performed by the central processing unit 1111.

At step 1501, the donor CU provides to each donor DU, the unique address of the donor DU. At step 1502, the donor CU provides routing configuration information to the plurality of IAB network nodes, the routing configuration information comprising a routing configuration table including at least one entry, each entry including a destination address field for the unique address of a donor DU corresponding to a destination donor DU for receiving data packets to be transmitted to the donor CU, and a path identifier field for a path identifier of a routing path for the destination donor DU, wherein the at least one entry in the routing configuration table includes the unique address of a first donor DU of the plurality of donor DUs as the destination donor DU in the destination address field, and a path identifier for a routing path to a second donor DU of the plurality of donor DUs, the second donor DU being different to the first donor DU. At step, 1503, the donor CU provides filtering configuration information relating to a predetermined filtering condition for configuring the second donor DU to accept a data packet for the destination donor DU for further processing when the predetermined filtering condition is met. Although the steps 1501-1503 are shown as three separate steps with step 1502 following step 1501 and step 1503 following step 1502, the donor CU may provide the information to the donor DUs, the IAB network nodes and the second donor DU in any order or simultaneously at the same time.

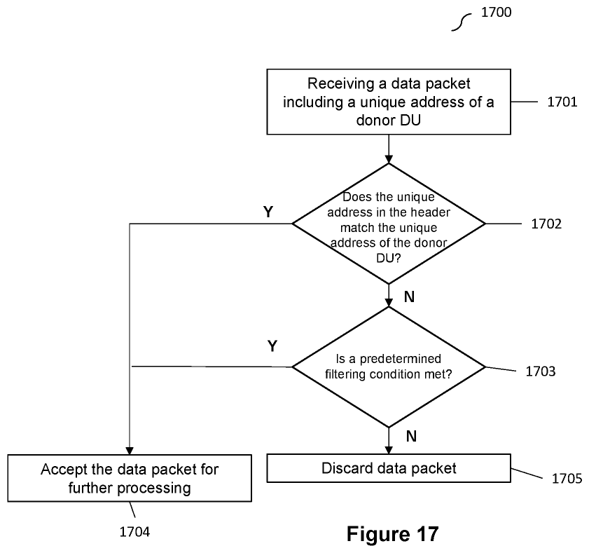

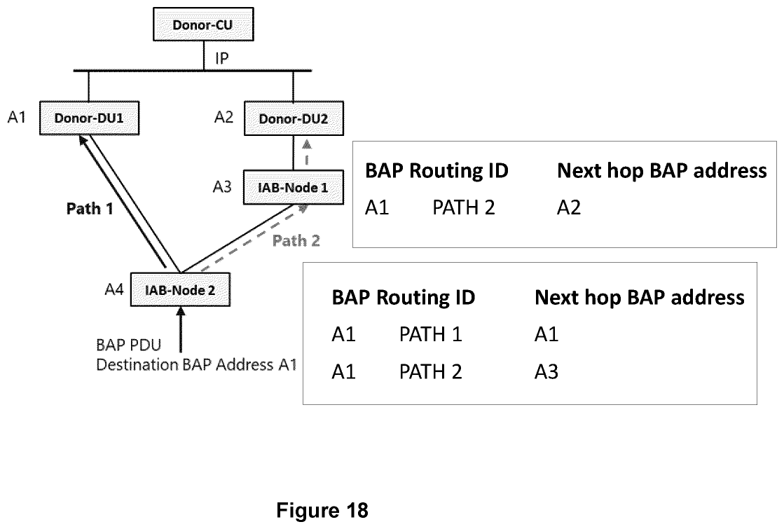

FIG. 16 shows steps of a method 1600, performed at an IAB node, for routing data packets over wireless backhaul links in an IAB network (for example, having a topology such as that shown in FIG. 6) comprising a donor network node and a plurality of IAB network nodes (such as IAB-nodes 611, 612, 613), the donor network node comprising a donor CU (such as IAB-donor-CU 610) and a plurality of donor DUs (such as IAB-donor-DUs 601, 602, 603) in accordance with the second embodiment of the invention. The IAB network node is configured with routing configuration information comprising a routing configuration table including at least one entry, each entry including a destination address field for the unique address of a donor DU corresponding to a destination donor DU for receiving data packets to be transmitted to the donor CU, and a path identifier field for a path identifier of a routing path for the destination donor DU, wherein the at least one entry in the routing configuration table includes the unique address of a donor DU of the plurality of donor DUs as the destination donor DU in the destination address field, and a path identifier for a routing path to a different donor DU of the plurality of donor DUs. The donor CU may be implemented in a communication device 1100 as shown in FIG. 11 below with the method as shown in FIG. 16 being performed by the central processing unit 1111.

At step 1601, the IAB network node receives a data packet for a destination donor DU. The data packet including (e.g. in a header of the data packet) the unique address of the destination donor DU for the data packet and a path identifier identifying the routing path to the destination donor DU. At step 1602, the IAB network node determines whether there is an available routing path to the destination donor DU based on the unique address of the destination donor DU and the path identifier included in the data packet and the routing configuration table. If it is determined that there is an available routing path, the data packet is routed using the available routing path at step 1605. When no available routing path is determined, the IAB network node determines, at step 1603, an alternate routing path for the data packet for the destination donor DU using the routing configuration table and based on the unique address of the destination donor DU. The alternate routing path is a routing path to a different donor DU to the destination donor DU. At step 1604, the IAB network node routes the data packet using the alternate routing path. The description below (in particular with respect to FIG. 8) provides more details regarding how the IAB network node handles the routing of data packets.

FIG. 17 shows steps of a method 1700, performed at a donor DU, for processing data packets in a wireless IAB network (for example, having a topology such as that shown in FIG. 6) comprising a donor network node and a plurality of IAB network nodes (such as IAB-nodes 611, 612, 613), the donor network node comprising a donor CU (such as IAB-donor-CU 610) and a plurality of donor DUs (such as IAB-donor-DUs 601, 602, 603) in accordance with the second embodiment of the invention. The donor DU is configured with configuration information including the unique address of the donor DU and filtering configuration information relating to a predetermined filtering condition. The donor CU may be implemented in a communication device 1100 as shown in FIG. 11 below with the method as shown in FIG. 17 being performed by the central processing unit 1111.

At step 1701, the donor DU receives a data packet which includes (e.g. in a header) the unique address of a donor DU corresponding to a destination donor DU for the data packet. At step 1702, the donor DU determines whether the unique address in the header matches the unique address of the donor DU in the configuration information. When the unique addresses do not match (No branch at step 1702), the donor DU then determines at step 1703 whether a predetermined filtering condition is met. If the predetermined filtering condition is not met (No branch at step 1703), the data packet is discarded at step 1705. When the predetermined filtering condition is met (Yes branch at step 1703), the donor DU accepts, at step 1704, the received data packet for further processing. For the arrangement in accordance with the second embodiment where at least one entry is added to the routing configuration table to provide an alternate path for a data packet for a destination donor DU to a different or alternative donor DU, the received data packets or BAP PDUs in IAB-donor-DUs may be processed according to the exemplary method described above with reference to FIG. 9. The routing configuration table and predetermined filtering condition can be provided according to the exemplary methods described above with reference to FIGS. 10 and 10a.

The received data packets or BAP PDUs in IAB-nodes may be processed according to the exemplary method similar to that described above with reference to FIG. 8. The steps 801-805 are the same. If there is no table entry for the Routing ID (No branch at step 803) or if the egress or BH link is not available (No branch at step 805), then the IAB-node searches for another entry in the routing configuration table (for example, the BH routing configuration table 500 of IAB-node 612 and 611 shown below with the additional entries according to the second embodiment) for which the destination BAP address in the field 501 matches the destination BAP address in the extracted BAP Routing ID. If another entry is found having a routing path to the destination IAB-donor DU, the BH link is selected according to the value of the field 502 of the found entry. A check is then made as to whether the selected egress or BH link is available (e.g. no radio link failure detected, no congestion detected). If yes, the steps 806 and 807 of FIG. 8 are executed. If the selected egress or BH link is not available, then another entry with a matching address entry and having a routing path to the destination IAB-donor DU is searched. In case there is no other entry matching the destination BAP address and having a routing path to the destination IAB-donor DU, the IAB-node searches for another entry in the routing configuration table for which the destination BAP address in the field 501 matches the destination BAP address in the extracted BAP Routing ID irrespective of whether the routing path is to the destination IAB-donor DU. If another entry is found having a routing path to a different IAB-donor DU, the BH link is selected according to the value of the field 502 of the found entry. A check is then made as to whether the selected egress or BH link is available (e.g. no radio link failure detected, no congestion detected). If yes, the steps 806 and 807 of FIG. 8 are executed. If no entry is found, the BAP PDU is discarded as per step 815.

For the arrangement in accordance with the second embodiment, the received data packets or BAP PDUs in IAB-donor-DUs may be processed according to the exemplary method described above with reference to FIG. 9. The routing configuration table and predetermined filtering condition can be provided according to the exemplary methods described above with reference to FIGS. 10 and 10a.

As discussed above, the predetermined filtering condition may include one of: all data packets received at the IAB-donor-DU can be accepted for further processing; or the unique address in the header of the data packet matches a unique address included in a list of unique addresses of acceptable IAB-donor-DUs provided to the IAB-donor-DU by the IAB-donor-CU; or the header of the data packet includes a group identifier (e.g. filtering group identifier) that matches a group identifier provided to the IAB-donor-DU by the IAB-donor-CU. The list of unique addresses of acceptable IAB-donor-DUs corresponds to a list of authorised unique addresses. The list may include unique addresses of IAB-donor-DUs belonging to the same group such as the same IP subnetwork. The group identifier may correspond to a group identifier assigned to one or more IAB-donor-DUs belonging to the same group such as the same IP subnetwork. The IAB-donor CU may provide filtering configuration information relating to the predetermined filtering condition to the IAB-donor-DUs to configure the IAB-donor-DUs. For example, the filtering configuration information may include an indication that all unique addresses are authorised, the list of authorised unique addresses or the group identifier. The filtering configuration information may be provided in an Information Element and may be provided to an IAB-donor-DU with the configuration information including the unique address assigned to the IAB-donor-DU. The predetermined filtering condition enables the IAB-donor DU to accept data packets which would otherwise be discarded and without the need to update the header of the data packet as the data packet is routed along alternate routing paths.

Thus, according to the second embodiment of the invention, the backhaul routing configuration table 500 is not augmented with a Group ID as described in the FIG. 7. However, this table 500 is configured by the IAB-donor-CU in a particular manner to provide a path (e.g. an alternate routing path) toward another IAB-donor-DU. In an example arrangement, the table 500 shall contain at least one other entry with the same BAP address as the initially targeted IAB-donor-DU and indicating a next hop BAP address of an IAB-node connected to an alternative or different IAB-donor-DU (there may be several intermediate IAB-nodes in between). Using again the example of FIG. 6, the BH routing configuration table 500 of IAB-node 612 may include the following entries:

| BAP Routing ID | Next hop BAP address |
|---|---|
| ID 1 (BAP Address IAB-donor-DU | BAP Address IAB-donor-DU |
| 601 + PATH 1) | 601 |
| ID 4 (BAP Address IAB-donor-DU | BAP Address IAB-node 611 |
| 601 + PATH 2) | |
| ID 2 (BAP Address IAB-donor-DU | BAP Address IAB-node 611 |
| 602 + PATH 2) | |
| ID 3 (BAP Address IAB-donor-DU | BAP Address IAB-node 611 |
| 603 + PATH 3) | |

Then, using the second entry (ID 4), JAB-node 612 has an alternate path to route through JAB-node 611 the BAP PDUs with BAP Routing ID 1.

The BH routing configuration table 500 of IAB-node 611 may include the following entries:

| BAP Routing ID | Next hop BAP address |
|---|---|
| ID 4 (BAP Address IAB-donor-DU | BAP Address IAB-donor-DU 602 |
| 601 + PATH 2) | |
| ID 2 (BAP Address IAB-donor-DU | BAP Address IAB-donor-DU 602 |
| 602 + PATH 2) | |
| ID 3 (BAP Address IAB-donor-DU | BAP Address IAB-donor-DU 603 |
| 603 + PATH 3) | |

Then, JAB-node 612 has the information that BAP PDUs with BAP Routing TD 1 (i.e. with the BAP address of IAB-donor-DU 601) are routed toward the IAB-donor-DU 602. Assuming that the IAB-donor-DU 602 has been configured by the JAB-donor-CU 610 to accept the BAP PDUs with DESTINATION field 305 in the header equals to the BAP address of the IAB-donor-DU 601 (e.g. the JAB-donor DU 602 has been configured such that all BAP addresses can be accepted, or provided with a list of acceptable BAP addresses which includes the BAP address for IAB-donor-DU 601 or the header includes a group identifier that has been provided to the IAB-donor-DU 602 as discussed above), the JAB-donor-DU 602 will determine that the BAP PDUs are acceptable or authorized (ie. a predetermined filtering condition has been met) so that these BAP PDUs can be delivered to the upper layers for further processing and up to the IAB-donor-CU 610. For example, see the steps in FIG. 9.

The inter-donor DU local re-routing is not feasible with Rel-16 IAB.

From the RAN2's view, there are two issues:
An IAB-node cannot re-route BAP PDUs in the upstream direction to an alternative donor-DU. Indeed, in case the egress link to transmit a BAP PDU according to the BAP routing ID is not available, an IAB-node selects an alternative egress link in the BH routing configuration table based on routing entries with the same destination BAP address, i.e., by disregarding the BAP path ID. In the upstream direction, the destination BAP address of BAP PDUs corresponds to one of the several IAB-donor-DUs available. As the IAB-donor-DUs are set with different BAP addresses, an IAB-node may find an alternative path in its routing table to reach the same IAB-donor-DU, but it has no information to identify an alternative IAB-donor-DU that could be reached through an alternative path.

One may observe that an IAB-node has no information in its BH routing configuration to identify an alternative IAB-donor-DU that could be reached through an alternative path in the upstream direction.
Assuming a BAP PDU arrives at an alternative IAB-donor-DU, this latter would discard the BAP PDU as the destination BAP address would not match its own BAP address.

One may observe that in the upstream direction, a re-routed BAP PDU arriving at an alternative IAB-donor-DU would be discarded as the destination BAP address of the BAP PDU would not match the BAP address of the alternative IAB-donor-DU.

Moreover, assuming that an IAB-donor-DU can receive a re-routed BAP PDU first intended to another IAB-donor-DU, the IP packet delivered to the upper layers may be discarded due to the IP filtering applied on the wireline network connecting the IAB-donor-DUs and the IAB-donor-CU. One of the option is to only allow re-routing among a configured subset of IAB-donor-DUs, where source IP filtering is not activated. Thus, source IP filtering may not be applied within IP subnets of limited size, and a BAP PDU conveying an IP packet belonging to a given IP subnet could be re-routed toward an IAB-donor-DU belonging to the same IP subnet.

One may observe that the re-routing of BAP PDUs may only be possible toward IAB-donor-DUs where source IP filtering is not activated or which belongs to the same IP subnet.

### Group of Donor-DUs and BH Routing Configuration Enhancement

To solve the above issues, it is proposed to gather IAB-donor-DUs into groups based, for instance, on the IP filtering policy in the wired backhaul network. It means that, regarding the IP filtering, the re-routing of BAP PDUs would be possible toward IAB-donor-DUs belonging to the same group as the IAB-donor-DU initially targeted. Each IAB-donor-DU is therefore associated to a Group ID defined by the IAB-donor-CU.

In one aspect of the invention, each IAB-donor-DU is associated to a Group ID defined by the IAB-donor-CU.

In one aspect of the invention, the grouping of donor DUs into groups may be based, for example, on the IP filtering policy in the wired backhaul network.

Then three options are proposed regarding the format and the usage of the Group ID:

### Option 1

The IAB-donor-CU provides routing configuration information to the IAB-nodes with at least one entry with the destination BAP address being the BAP address of the targeted IAB-donor-DU (indicated in the BAP header), and the path ID and the next hop BAP address of the entry indicating an alternative path towards another IAB-donor-DU.

With such entry, the IAB-nodes can follow the routing operations defined in Rel-16 to route a BAP PDU up to an IAB-donor-DU different from the IAB-donor-DU targeted by the BAP Routing ID in the header. With the example of Error! Reference source not found.8, the IAB-node 2 has an alternative path toward IAB-node 1 to re-route a BAP PDU with destination BAP address A1. Also, the IAB-node 1 has a path defined toward IAB-Donor-DU2 in its BH routing configuration.

In one aspect of the invention, the IAB-donor-CU provides routing configuration information to the IAB-nodes with at least one entry with the destination BAP address being the BAP address of the targeted IAB-donor-DU, and the path ID and the next hop BAP address of the entry indicating an alternative path towards another IAB-donor-DU.

### Option 2

The Group ID is provided by the IAB-donor-CU to the IAB-nodes as an additional parameter in their BH routing configuration. For instance, each entry of the BH routing configuration includes a Group ID field to identify the group associated with the destination BAP address in the entry. Thus, an IAB-node willing to re-route a BAP PDU in the upstream direction, will be able to select an alternative destination BAP address that belongs to the same group as the destination BAP address indicated in the BAP header of the BAP PDU. The Group ID field may be represented with few bits. One bit may even be sufficient assuming there is no IP filtering in the wired backhaul.

In one aspect of the invention, the Group ID is provided by the IAB-donor-CU to the IAB-nodes as an additional parameter in their BH routing configuration.

### Option 3

The Group ID may consist of a Group address representing a secondary BAP address for an IAB-donor-DU. Thus, each IAB-donor-DU is configured by the IAB-donor-CU with a unique BAP address and a Group address, and each of the IAB-donor-DUs in a group is configured with the same group address.

In such a case, the BH routing configuration may comprise entries with a Group address as the destination BAP address. Several entries with the same Group address may be provided by the IAB-donor-CU in case several paths exists towards IAB-donor-DUs belonging to the same group.

Besides, when an IAB-node generates a BAP PDU, the destination BAP address may be the Group address to allow local re-routing to allow local re-routing toward a different IAB-donor-DU within the same group.

In one aspect of the invention, the Group ID may consist of a Group address representing a secondary BAP address for an IAB-donor-DU, and configured by the IAB-donor-CU along with the unique BAP address.

In one aspect of the invention, an IAB-node generating a BAP PDU may select a Group address as the destination BAP address for the BAP PDU.

### BAP Routing ID Update

In relation with the option 2 above, when local re-routing toward a different IAB-donor-DU is applied by an IAB-node, the BAP Routing ID in the header of BAP PDUs may be updated to reflect the new destination BAP address and the new path followed by the BAP PDUs.

By updating the header to include the unique BAP address of the different IAB-donor DU, the specifications of the routing operations of the next IAB-nodes may be unchanged. Furthermore, additional processing at the different IAB-donor DU, which would be required to avoid BAP PDUs being discarded if the header was not updated, can be avoided.

In one aspect of the invention, an IAB-node may update the BAP routing ID of the BAP PDUs that are re-routed toward a different IAB-donor-DU.

### Receiving Operation Enhancement

To avoid discarding a received BAP PDU at an IAB-donor-DU because the destination BAP address is different from its unique BAP address, the IAB-donor-DU may be configured by the IAB-donor-CU with a new filtering condition.

The new filtering condition may include one of the followings:
All BAP PDUs received at the IAB-donor-DU can be accepted for further processing,
The destination BAP address in the header of the BAP PDU matches a unique BAP address included in a list of unique BAP addresses of acceptable IAB-donor-DUs provided by the IAB-donor-CU,
The header of the BAP PDU includes a Group address that matches a Group address provided by the IAB-donor-CU.

In one aspect of the invention, the IAB-donor-DUs may be configured by the IAB-donor-CU with a new filtering condition applied when receiving BAP PDUs.

FIG. 11 shows a schematic representation of an example communication device or station, in accordance with one or more embodiments and examples of the present disclosure.

The communication device 1100 may preferably be a device such as a microcomputer, a workstation or a light portable device. The communication device 1100 comprises a communication bus 1113 to which there are preferably connected:
a central processing unit 1111, such as a microprocessor, denoted CPU;
memory for storing data and computer programs containing instructions for the operation of the communication device 1100. The computer programs may contain a number of different program elements or sub-routines containing instructions for a variety of operations and for implementing the invention. For example, the program elements include an element to implement a BAP entity which as discussed above is for routing of data packets between different network nodes in the IAB network; and
at least one communication interface 1102 connected to the radio communication network 100 over which digital data packets or frames or control frames are transmitted, for example a wireless communication network according to the release 16 for 5G NR. The frames are written from a FIFO sending memory in RAM 1112 to the network interface for transmission or are read from the network interface for reception and writing into a FIFO receiving memory in RAM 1112 under the control of a software application running in the CPU 1111.

Each of a donor CU, an IAB network node and a donor DU may comprise such a communication device 1100.

The central processing unit 1111 may be a single processor or may comprise two or more processors carrying out the processing required for the operation of the communication device 1100. The number of processors and the allocation of processing functions to the central processing unit 1111 is a matter of design choice for a skilled person.

The memory may include:
a read only memory 1107, denoted ROM, for storing computer programs for implementing the invention;
a random-access memory 1112, denoted RAM, for storing the executable code of methods according to one or more embodiments of the invention as well as the registers adapted to record variables and parameters necessary for implementing methods according to one or more embodiments of the invention.

Optionally, the communication device 1100 may also include the following components:
a data storage means 1104 such as a hard disk, for storing computer programs for implementing methods according to one or more embodiments of the invention;
a disk drive 1105 for a disk 1106, the disk drive being adapted to read data from the disk 1106 or to write data onto said disk;
a screen 1109 for displaying decoded data and/or serving as a graphical interface with the user, by means of a keyboard 1110 or any other pointing means.

Preferably the communication bus provides communication and interoperability between the various elements included in the communication device 1100 or connected to it. The representation of the bus is not limiting and in particular, the central processing unit is operable to communicate instructions to any element of the communication device 1100 directly or by means of another element of the communication device 1100.

The disk 1106 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1107, on the hard disk 1104 or on a removable digital medium such as for example a disk 1106 as described previously. According to an optional variant, the executable code of the programs can be received by means of the communication network 1103, via the interface 1102, in order to be stored in one of the storage means of the communication device 1100, such as the hard disk 1104, before being executed.

The central processing unit 1111 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1104 or in the read only memory 1107, are transferred into the random-access memory 1112, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC).

1. A method for managing routing of data packets over wireless backhaul links in an integrated access and backhaul, IAB, network comprising a donor network node and a plurality of IAB network nodes, the donor network node comprising a donor central unit, CU, and a plurality of donor distributed units, DUs, each donor DU being assigned a unique address and each donor DU being assigned to one of one or more groups with a unique group identifier assigned to each group of the one or more groups, the method at the donor CU comprising:
providing to each donor DU, the unique address of the donor DU;
providing routing configuration information to the plurality of IAB network nodes, the routing configuration information including the unique addresses of the donor DUs corresponding to destination donor DUs for data packets to be transmitted to the donor CU, path identifiers identifying routing paths to the destination donor DUs, and the group identifiers associated with the destination donor DUs.

2. The method of claim 1, wherein the routing configuration information comprises a routing configuration table including at least one entry, each entry having a destination address field for the unique address of a destination donor DU, a path identifier field for the path identifier of a routing path to the destination donor DU, a group identifier field for the group identifier associated with the destination donor DU.

3. The method of claim 1, wherein the routing configuration information comprises a routing configuration table including at least one entry, each entry having a destination address field for the unique address of a destination donor DU and the group identifier associated with the destination donor DU, and a path identifier field for the path identifier of a routing path to the destination donor DU.

4. The method of claim 3, wherein the group identifier is represented by one or more bits in the destination address field of the routing configuration table.

5. The method of claim 1, wherein the group identifier is a group address, wherein each of the donor DUs in a group is assigned the same group address such that each donor DU is assigned a unique address and a group address.

6. The method of claim 5, wherein the routing configuration information comprises a routing configuration table including at least one entry, each entry having a destination address field for the unique address of a destination donor DU or the group address of the destination donor DU, and a path identifier field for the path identifier of a routing path to the destination donor DU.

7. The method of claim 2, wherein a unique address is assigned to each IAB network node in the IAB network,
wherein the routing configuration table further comprises a next-hop address field for the unique address of a donor DU or IAB network node of the IAB network that is next in the routing path.

8. The method of claim 3, wherein the routing configuration table is a Backhaul Adaptation Protocol, BAP, routing configuration table with each entry having a BAP routing identifier comprising the destination address field and the path identifier field.

9. The method of claim 1, wherein each group of the one or more groups is associated with a respective IP subnetwork of an IP network coupled between the donor CU and the plurality of donor DUs.

10. A method, at an IAB network node, for routing data packets over one or more wireless backhaul links in an integrated access and backhaul, IAB, network comprising a donor network node and a plurality of IAB network nodes, the donor network node comprising a donor central unit, CU, and a plurality of donor distributed units, DUs, each donor DU and IAB network node being assigned a unique address and each donor DU being assigned to one of one or more groups with a unique group identifier assigned to each group of the one or more groups, the IAB network node being configured with routing configuration information including a unique address of at least one donor DU corresponding to at least one destination donor DU for data packets to be transmitted by the IAB network node, at least one path identifier identifying at least one routing path to the at least one destination donor DU, the unique address of a donor DU or IAB network node of the IAB network that is a next node in the at least one routing path and the group identifier associated with the at least one destination donor DU, the method comprising:
receiving a data packet for a destination donor DU, the data packet including the unique address of the destination donor DU for the data packet and a path identifier identifying the routing path to the destination donor DU;
determining whether there is an available routing path to the destination donor DU based on the unique address of the destination donor DU and the path identifier included in the data packet and the routing configuration information, and based on the unique address of the destination donor DU included in the data packet and the routing configuration information,
when no available routing path is determined, determining an alternate routing path for the data packet for the destination donor DU using the routing configuration information and based on the unique address of the destination donor DU and the group identifier associated with the destination donor DU, wherein the alternate routing path is to a different destination donor DU in the same group as the destination donor DU with the same group identifier;
routing the data packet using the determined alternate routing path.

11. The method of claim 10, wherein the data packet includes a header comprising the unique address of the destination donor DU for the data packet, when the data packets is to be routed using a routing path to a different donor DU in the same group as the destination donor DU, the method further comprises updating the header of the data packet to include the unique address of the different donor DU or to replace the unique address of the destination donor DU with the unique address of the different donor DU, wherein routing the data packet comprises routing the data packet including an updated header.

12. The method of claim 10, wherein the routing configuration information comprises a routing configuration table including at least one entry, each entry having:
a destination address field for the unique address of a destination donor DU, a path identifier field for the path identifier of a routing path to the destination donor DU, a next-hop address field for the unique address of a donor DU or IAB network node of the IAB network that is a next node in the routing path, and a group identifier field for the group identifier associated with the destination donor DU; or
a destination address field for the unique address of the destination donor DU and the group identifier associated with the destination donor DU, a path identifier field for the path identifier of a routing path to the destination donor DU, and a next-hop address field for the unique address of a donor DU or IAB network node of the IAB network that is a next node in the routing path.

13. The method of claim 12, wherein determining whether there is an available routing path to the destination donor DU comprises:
comparing the unique address of the destination donor DU and the path identifier included in the data packet with the routing configuration table and when there is a match with a unique address and path identifier in an entry of the routing configuration table, checking whether a backhaul wireless link to a next node in the routing path identified by the unique address in the next-hop address field for the entry is available;
when the backhaul wireless link is not available or there is no match with a unique address and path identifier in the routing configuration table, comparing the unique address of the destination donor DU included in the data packet with the routing configuration table and when there is a match with a unique address in an entry of the routing configuration table, checking whether a backhaul wireless link to a next node identified by the unique address in the next-hop address field for the entry is available, wherein no available routing path is determined when there is no match with a unique address in the routing configuration table or the backhaul wireless link is not available,
wherein determining an alternate routing path comprises:
identifying another entry in the routing configuration table having the same group identifier as the group identifier for an entry having at least the unique address of the destination donor in the destination address field, and determining, from the next-hop address field of the another entry, an alternate routing path to a different destination donor DU in the same group as the destination donor DU.

14. The method of claim 13, wherein routing the data packet using the determined alternate routing path comprises checking whether a backhaul wireless link to a next node in the routing path identified by the unique address in the next-hop address field for the another entry is available and when the backhaul wireless link is available routing the data packet using the determined alternate routing path.

15. The method of claim 10, wherein the group identifier is a group address, wherein each of the donor DUs in a group is assigned the same group address such that each donor DU is assigned a unique address and a group address.

16. The method of claim 15, wherein the routing configuration information comprises a routing configuration table including at least one entry, each entry having a destination address field for the unique address of a destination donor DU or the group address of the destination donor DU, a path identifier field for the path identifier of a routing path to the destination donor DU and a next-hop address field for the unique address of a donor DU or IAB network node of the IAB network that is next in the routing path.

17. The method of claim 16, wherein determining whether there is an available routing path to the destination donor DU comprises:
comparing the unique address of the destination donor DU and the path identifier included in the data packet with the routing configuration table and when there is a match with a unique address and path identifier in an entry of the routing configuration table, checking whether a backhaul wireless link to a next node in the routing path identified by the unique address in the next-hop address field for the entry is available;
when the backhaul wireless link is not available or there is no match with a unique address and path identifier in the routing configuration table, comparing the unique address of the destination donor DU included in the data packet with the routing configuration table and when there is a match with a unique address in an entry of the routing configuration table, checking whether a backhaul wireless link to a next node identified by the unique address in the next-hop address field for the entry is available, wherein no available routing paths are determined when there is no match with a unique address in the routing configuration table or the backhaul wireless link is not available,
wherein determining an alternate routing path comprises:
identifying another entry in the routing configuration table having the group address corresponding to the unique address or the same group address as the group address for an entry having the unique address of the destination donor in the destination address field and determining, from the another entry, an alternate routing path to a different destination donor DU with the same group address as the destination donor DU.

18. The method of claim 17, wherein routing the data packet using the determined alternate routing path comprises checking whether a backhaul wireless link to a next node in the routing path identified by the unique address in the next-hop address field for the another entry is available and when the backhaul wireless link is available routing the data packet using the determined alternate routing path.

19. The method of claim 15, further comprising:
generating a data packet for routing to a destination donor DU, wherein the data packet includes the unique address or the group address of the destination donor DU.

20. A method for processing data packets at a donor DU of a wireless integrated access and backhaul, IAB, network comprising a donor network node and a plurality of IAB network nodes, the donor network node comprising a donor central unit, CU, and a plurality of donor distributed units, DUs, each donor DU being assigned a unique address and each donor DU being assigned to one of one or more groups with a unique group identifier assigned to each group of the one or more groups, the donor DU being configured with configuration information including the unique address of the donor DU and the group identifier associated with the donor DU, the method comprising:
receiving a data packet, the data packet including a header comprising the unique address of a donor DU corresponding to a destination donor DU for the data packet;
determining whether the unique address in the header matches the unique address of the donor DU in the configuration information;
when the unique addresses do not match, determining whether a predetermined filtering condition is met;
when the predetermined filtering condition is met, accepting the received data packet for further processing.

21. A method for processing data packets at a donor DU of a wireless integrated access and backhaul, IAB, network comprising a donor network node and a plurality of IAB network nodes, the donor network node comprising a donor central unit, CU, and a plurality of donor distributed units, DUs, each donor DU being assigned a unique address and each donor DU being assigned to one of one or more groups with a group address assigned to each group of the one or more groups, wherein each of the donor DUs in a group is assigned the same group address such that each donor DU is assigned a unique address and a group address, the donor DU being configured with configuration information including the unique address of the donor DU and the group address associated with the donor DU, the method comprising:
receiving a data packet, the data packet including a header comprising the unique address of a donor DU or the group address of the donor DU corresponding to a destination donor DU for the data packet;
determining whether the unique address or the group address in the header matches the unique address or the group address of the donor DU in the received routing configuration information;
when the unique addresses or the group addresses match, accepting the received data packet for further processing.

22. The method of claim 21, wherein when the unique addresses or the group addresses do not match, determining whether a predetermined filtering condition is met and when the predetermined filtering condition is met, accepting the received data packet for further processing.

23. The method of claim 22, wherein the predetermined filtering condition includes one of:
all data packets received at the donor DU can be accepted for further processing; or
the unique address in the header of the data packet matches a unique address included in a list of unique addresses of acceptable donor DUs provided to the donor DU by the donor CU; or
the header of the data packet includes a group identifier that matches a group identifier provided to the donor DU by the donor CU.

24-34. (canceled)

35. Apparatus for an Integrated access and backhaul, IAB, network node for routing data packets over wireless backhaul links in an IAB network comprising a plurality of IAB network nodes and a donor network node including a donor Central Unit, CU, and a plurality of donor distributed units, DUs, each donor DU and IAB network node being assigned a unique address and each donor DU being assigned to one of one or more groups with a unique group identifier assigned to each group of the one or more groups, the IAB network node being configured with routing configuration information including a unique address of at least one donor DU corresponding to at least one destination donor DU for data packets to be transmitted by the IAB network node, at least one path identifier identifying at least one routing path to the at least one destination donor DU, the unique address of a donor DU or IAB network node of the IAB network that is a next node in the at least one routing path and the group identifier associated with the at least one destination donor DU, the apparatus comprising:
at least one processor configured to:
receive a data packet for a destination donor DU, the data packet including the unique address of the destination donor DU for the data packet and a path identifier identifying the routing path to the destination donor DU;
determine whether there is an available routing path to the destination donor DU based on the unique address of the destination donor DU and the path identifier included in the data packet and the routing configuration information, and based on the unique address of the destination donor DU included in the data packet and the routing configuration information,
when no available routing path is determined, determine an alternate routing path for the data packet for the destination donor DU using the routing configuration information and based on the unique address of the destination donor DU and the group identifier associated with the destination donor DU, wherein the alternate routing path is to a different destination donor DU in the same group as the destination donor DU with the same group identifier;
route the data packet using the determined alternate routing path.

36. Apparatus for a donor Distributed unit, DU, for processing data packets in a wireless integrated access and backhaul, IAB, network comprising a plurality of IAB network nodes and a donor network node including a donor Central Unit, CU, and a plurality of donor distributed units, DUs, each donor DU being assigned a unique address and each donor DU being assigned to one of one or more groups with a unique group identifier assigned to each group of the one or more groups, the donor DU being configured with configuration information including the unique address of the donor DU and the group identifier associated with the donor DU, the apparatus comprising:
at least one processor configured to:
receive a data packet, the data packet including a header comprising the unique address of a donor DU corresponding to a destination donor DU for the data packet;
determine whether the unique address in the header matches the unique address of the donor DU in the configuration information;
when the unique addresses do not match, determine whether a predetermined filtering condition is met;
when the predetermined filtering condition is met, accept the received data packet for further processing.

37. The method of claim 2, wherein the group identifier is represented by one or more bits in the group identifier field.

38. The method of claim 2, wherein the routing configuration table is a Backhaul Adaptation Protocol, BAP, routing configuration table with each entry having a BAP routing identifier comprising the destination address field and the path identifier field.

39. The method of claim 20, wherein the predetermined filtering condition includes one of:
all data packets received at the donor DU can be accepted for further processing; or
the unique address in the header of the data packet matches a unique address included in a list of unique addresses of acceptable donor DUs provided to the donor DU by the donor CU; or
the header of the data packet includes a group identifier that matches a group identifier provided to the donor DU by the donor CU.

40. The apparatus of claim 35, wherein the data packet includes a header comprising the unique address of the destination donor DU for the data packet, when the data packets is to be routed using a routing path to a different donor DU in the same group as the destination donor DU, the at least one processor is further configured to update the header of the data packet to include the unique address of the different donor DU or to replace the unique address of the destination donor DU with the unique address of the different donor DU.

41. The apparatus of claim 35, wherein the routing configuration information comprises a routing configuration table including at least one entry, each entry having:
a destination address field for the unique address of a destination donor DU, a path identifier field for the path identifier of a routing path to the destination donor DU, a next-hop address field for the unique address of a donor DU or IAB network node of the IAB network that is a next node in the routing path, and a group identifier field for the group identifier associated with the destination donor DU; or
a destination address field for the unique address of the destination donor DU and the group identifier associated with the destination donor DU, a path identifier field for the path identifier of a routing path to the destination donor DU, and a next-hop address field for the unique address of a donor DU or IAB network node of the IAB network that is a next node in the routing path.

42. The apparatus of claim 41, wherein the at least one processor is configured to determine whether there is an available routing path to the destination donor DU by:
comparing the unique address of the destination donor DU and the path identifier included in the data packet with the routing configuration table and when there is a match with a unique address and path identifier in an entry of the routing configuration table, checking whether a backhaul wireless link to a next node in the routing path identified by the unique address in the next-hop address field for the entry is available;
when the backhaul wireless link is not available or there is no match with a unique address and path identifier in the routing configuration table, comparing the unique address of the destination donor DU included in the data packet with the routing configuration table and when there is a match with a unique address in an entry of the routing configuration table, checking whether a backhaul wireless link to a next node identified by the unique address in the next-hop address field for the entry is available, wherein no available routing path is determined when there is no match with a unique address in the routing configuration table or the backhaul wireless link is not available,
wherein the at least one processor is configured to determine an alternate routing path by:
identifying another entry in the routing configuration table having the same group identifier as the group identifier for an entry having at least the unique address of the destination donor in the destination address field, and determining, from the next-hop address field of the another entry, an alternate routing path to a different destination donor DU in the same group as the destination donor DU.

43. The apparatus of claim 42, wherein the at least one processor is configured to route the data packet using the determined alternate routing path by checking whether a backhaul wireless link to a next node in the routing path identified by the unique address in the next-hop address field for the another entry is available and when the backhaul wireless link is available routing the data packet using the determined alternate routing path.

44. The apparatus of claim 35, wherein the group identifier is a group address, wherein each of the donor DUs in a group is assigned the same group address such that each donor DU is assigned a unique address and a group address.

45. The apparatus of claim 44, wherein the routing configuration information comprises a routing configuration table including at least one entry, each entry having a destination address field for the unique address of a destination donor DU or the group address of the destination donor DU, a path identifier field for the path identifier of a routing path to the destination donor DU and a next-hop address field for the unique address of a donor DU or IAB network node of the IAB network that is next in the routing path.

46. The apparatus of claim 45, wherein the at least one processor is configured to determine whether there is an available routing path to the destination donor DU by:
comparing the unique address of the destination donor DU and the path identifier included in the data packet with the routing configuration table and when there is a match with a unique address and path identifier in an entry of the routing configuration table, checking whether a backhaul wireless link to a next node in the routing path identified by the unique address in the next-hop address field for the entry is available;
when the backhaul wireless link is not available or there is no match with a unique address and path identifier in the routing configuration table, comparing the unique address of the destination donor DU included in the data packet with the routing configuration table and when there is a match with a unique address in an entry of the routing configuration table, checking whether a backhaul wireless link to a next node identified by the unique address in the next-hop address field for the entry is available, wherein no available routing paths are determined when there is no match with a unique address in the routing configuration table or the backhaul wireless link is not available,
wherein the at least one processor is configured to determine an alternate routing path by:
identifying another entry in the routing configuration table having the group address corresponding to the unique address or the same group address as the group address for an entry having the unique address of the destination donor in the destination address field and determining, from the another entry, an alternate routing path to a different destination donor DU with the same group address as the destination donor DU.

47. The apparatus of claim 46, wherein the at least one processor is configured to route the data packet using the determined alternate routing path by checking whether a backhaul wireless link to a next node in the routing path identified by the unique address in the next-hop address field for the another entry is available and when the backhaul wireless link is available routing the data packet using the determined alternate routing path.

48. The apparatus of claim 36, wherein the predetermined filtering condition includes one of:
all data packets received at the donor DU can be accepted for further processing; or
the unique address in the header of the data packet matches a unique address included in a list of unique addresses of acceptable donor DUs provided to the donor DU by the donor CU; or
the header of the data packet includes a group identifier that matches a group identifier provided to the donor DU by the donor CU.
